(19) United States
(12) Patent Application Publication
(10) Pub. No.: US 2014/0348467 A1
(43) Pub. Date: Nov. 27, 2014

(54) TILTABLE GANG FIBER ADAPTOR ASSEMBLY

(71) Applicant: CORNING OPTICAL COMMUNICATIONS LLC, HICKORY, NC (US)

(72) Inventors: Monique Lise Cote, Fort Worth, TX (US); William Julius McPhil Giraud, Azle, TX (US); Diana Rodriguez, Fort Worth, TX (US); Kenneth Charles Simonson, Coppell, TX (US)

(73) Assignee: CORNING OPTICAL COMMUNICATIONS LLC, HICKORY, NC (US)

(21) Appl. No.: 14/280,986

(22) Filed: May 19, 2014

Related U.S. Application Data
(60) Provisional application No. 61/825,772, filed on May 21, 2013.

(51) Int. Cl. G02B 6/44; G02B 6/36; G02B 6/38

(52) U.S. Cl. CPC G02B 6/4453; G02B 6/3897; G02B 6/3616
USPC 385/71

(57) ABSTRACT

A gang adaptor assembly that comprises a plurality of adaptors positioned adjacent to one another along a longitudinal axis is disclosed A first connector is disposed at a first end of the gang adaptor assembly and configured to tiltably connect the plurality of adaptors to a cassette. A second connector is disposed at a second end of the gang adaptor assembly and configured to tiltably connect the plurality of adaptors to a cassette. A latch actuator is disposed on at least one of first and second ends. The latch mechanism has a cam surface for actuating a latch mechanism on the cassette. A stop is disposed on at least one of first and second ends. The stop is configured to prevent the plurality of adaptors for rotating within cassette beyond an angle α.

### RELATED APPLICATIONS

This application claims the benefit of priority under 35 U.S.C. §119 of U.S. Provisional Application No. 61/825,772 filed on May 21, 2013, the content of which is relied upon and incorporated herein by reference in its entirety.

### BACKGROUND

1. Field of the Disclosure

The disclosure relates generally to fiber optic components, and particularly to optical fiber adaptors used to connect optical fibers in fiber optic cables.

2. Technical Background

In optical cable networking apparatus including convergence points and distribution frames, such as in fiber-optics networking, there is a constant demand for apparatus permitting high-density distribution with very high fiber termination counts in a small, confined volume. Ongoing needs exist for optical fiber apparatus having features that make installing, establishing maintaining, and repairing network connections more convenient and efficient. Optical fiber adaptors or adaptor banks which may be used in fiber optic distribution frames located in structures such as, for example, central offices and fiber optic local convergence points like outdoor cabinets.

### SUMMARY

One embodiment of the disclosure relates to a gang adaptor assembly that comprises a plurality of adaptors positioned adjacent to one another along a longitudinal axis; a first connector disposed at a first end of the gang adaptor assembly and configured to tiltably connect the plurality of adaptors to a cassette; a second connector disposed at a second end of the gang adaptor assembly and configured to tiltably connect the plurality of adaptors to a cassette; a latch actuator disposed on at least one of first and second ends, the latch mechanism having a cam surface for actuating a latch mechanism on the cassette; and a stop disposed on at least one of first and second ends, the stop configured to prevent the plurality of adaptors for rotating within cassette beyond an angle α.

An additional embodiment of the disclosure relates to a gang adaptor assembly that comprises a holder having a longitudinal axis, a first end, a second end opposite the first end; a first connector disposed at the first end, wherein the first connector includes a first stem extending from the first end along the longitudinal axis and a first head disposed on a distal end of the stem; a second connector disposed at the second end, wherein the second connector includes a second stem extending from the second end along the longitudinal axis and a second head disposed on a distal end of the stem; a plurality of adaptors positioned adjacent to one another along a longitudinal axis; and a latch actuator disposed on at least one of first and second ends, the latch mechanism having a cam surface for actuating a latch mechanism on the cassette.

An additional embodiment of the disclosure relates to an optical fiber cassette that comprises a framework having a first side and a second side opposite the first side, wherein the framework includes a first stem aperture disposed within the first side and a second stem aperture disposed within the second side opposite and axially-aligned with the first stem; and a gang adaptor assembly that includes a first end, a second end opposite the first end, a plurality of adaptors positioned adjacent to one another along a longitudinal axis between first and second ends, a first connector disposed at the first end, the first connector comprising a first stem extending from the first end and received with the first stem aperture, a second connector disposed at the second end, the second connector comprising a second stem extending from the second end and received with the second stem aperture, and a latch actuator disposed on at least one of first and second ends, the latch mechanism having a cam surface for actuating a latch mechanism on the cassette. The first and second connectors tiltably connect the plurality of adaptors to the framework, permitting the plurality of adaptors to tilt relative to the framework.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a right front perspective view of one embodiment of a gang adaptor assembly;

FIG. 2 is a left rear perspective view of the gang adaptor assembly of FIG. 1;

FIG. 3 is a right front perspective view of the gang adaptor assembly of FIG. 1 connected to a optical fiber cassette;

FIG. 4 is a left front perspective view of an embodiment of an adaptor assembly;

FIG. 5 is a left bottom perspective of an embodiment of a gang adaptor assembly, having a plurality of the adaptor assemblies of FIG. 4;

FIG. 6A is a left front perspective view of an embodiment of an adaptor holder;

FIG. 6B is a right front perspective view of the adaptor holder of FIG. 6A;

FIG. 7 is a top planar view of the gang adaptor assembly of FIG. 5;

FIG. 8 is a right front exploded perspective view of an embodiment of an adaptor assembly;

FIG. 9 is a right front perspective view of the adaptor assembly of FIG. 8;

FIG. 10 is a left rear perspective view of a first portion of the adaptor assembly of FIG. 8 separated from a second portion;

FIG. 11A is a cross sectional view of the adaptor assembly of FIG. 8, wherein the first and second portions are connected together;

FIG. 11B is a cross sectional view of the adaptor assembly of FIG. 8, wherein the first and second portions are disconnected from each other;

FIG. 12 is a left front perspective view of an embodiment of an adaptor holder, showing the adaptor assembly of FIG. 8 operable to connect to the adaptor holder;

FIG. 13 is a left front perspective view of an embodiment of a gang adaptor assembly having a plurality of adaptor assemblies of FIG. 8 connected to the adaptor holder of FIG. 12;

FIG. 14 is a top planar view of the gang adaptor assembly of FIG. 13;

FIG. 15 is a right front perspective view of the gang adaptor assembly of FIG. 13 connected to a optical fiber cassette;

FIG. 16 is a detail of a right front perspective view of a first end of the gang adaptor assembly and cassette of FIG. 15;

FIG. 17 is a right front perspective view of an embodiment of a gang adaptor assembly connected to a optical fiber cassette;

FIG. 18 is a right front perspective view of an embodiment of a gang adaptor assembly connected to a optical fiber cassette;

FIG. 19 is a right front perspective view of an embodiment of a gang adaptor assembly connected to a optical fiber cassette;

FIG. 20 is a detail of a right perspective view of an adaptor holder of the gang adaptor assembly of FIG. 19;

FIG. 21 is a right top perspective view of the cassette of FIG. 19;

FIG. 22 is a right front perspective view of the cassette of FIG. 19;

FIG. 23 is a detail of a right bottom perspective view of the cassette of FIG. 19;

FIG. 24 is a detail of a right front perspective view of the cassette of FIG. 19, wherein the adaptor holder is shown in a load/unload position;

FIG. 25 is a detail of a right front perspective of the cassette of FIG. 24, wherein the adaptor holder is shown in a second position;

FIG. 26 is a detail of a right front perspective of the cassette of FIG. 24, wherein the adaptor holder is shown in a first position;

FIG. 27 is a detail of a right front perspective of the cassette of FIG. 26;

FIG. 28 is a partial detail of a right perspective view of the cassette of FIG. 19;

FIG. 29 is a partial detail of a right perspective view of the cassette of FIG. 19;

FIG. 30 is a partial detail of a right perspective view of the cassette of FIG. 19;

FIG. 31 is a partial detail of a right perspective view of the cassette of FIG. 19;

FIG. 32 is a partial side elevational view of the cassette of FIG. 19;

FIG. 33A is a partial side elevational view of the cassette of FIG. 19, wherein the gang adaptor assembly is in the second position;

FIG. 33B is a partial side elevational view of the cassette of FIG. 19, wherein the gang adaptor assembly is in the second position;

FIG. 33C is a partial side elevational view of the cassette of FIG. 19, wherein the gang adaptor assembly is in the first position;

FIG. 34 is an exploded perspective view of an embodiment of a gang adaptor assembly and an optical fiber cassette;

FIG. 35 is a partial detail view of the gang adaptor assembly and optical fiber cassette of FIG. 34;

FIG. 36 is a right front perspective view of an embodiment of the cassette of FIG. 34, wherein an adaptor holder is in a second position;

FIG. 37 is a right front perspective view of the cassette of FIG. 36, wherein the adaptor holder is in a first position;

FIG. 38 is an exploded perspective view of an embodiment of a gang adaptor assembly and an optical fiber cassette;

FIG. 39 is a right front perspective view of the cassette of FIG. 38, wherein an adaptor holder is in a second position; and

FIG. 40 is a right front perspective view of the cassette of FIG. 39, wherein the adaptor holder is in a first position.

### DETAILED DESCRIPTION

Various embodiments will be further clarified by the following examples.

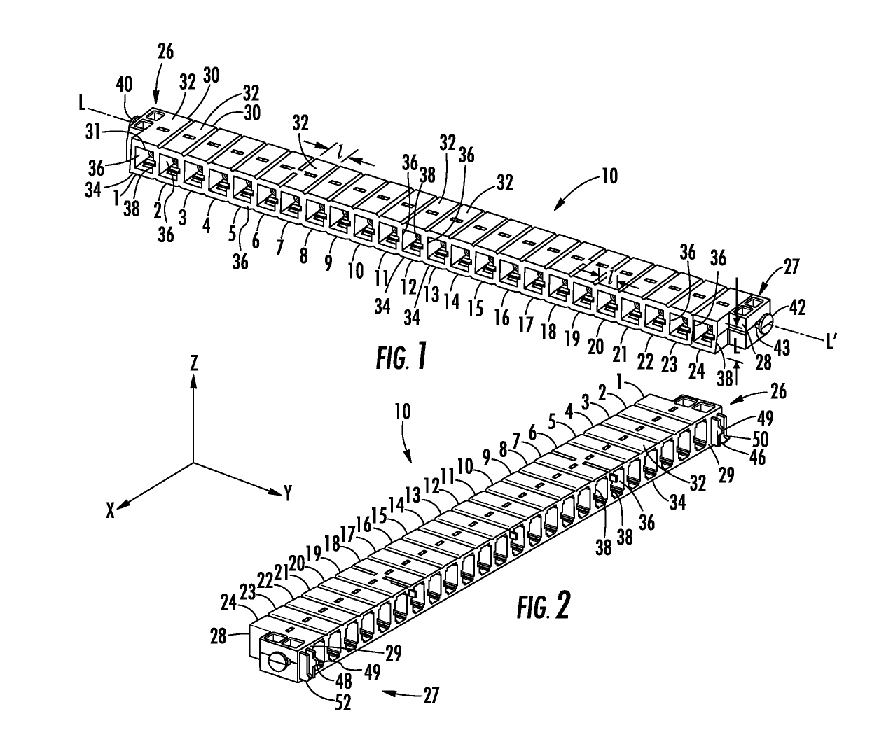

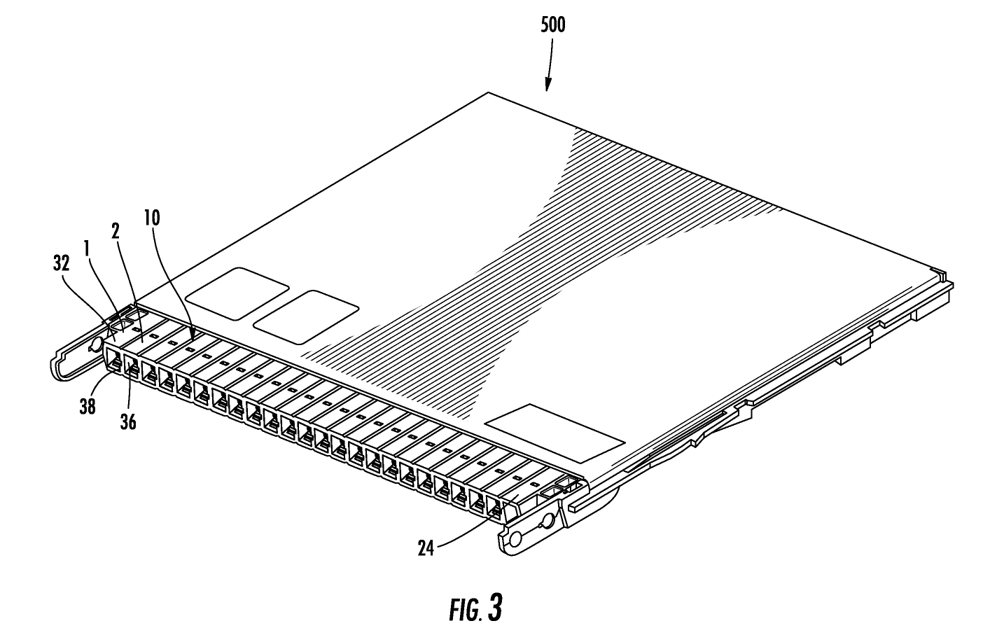

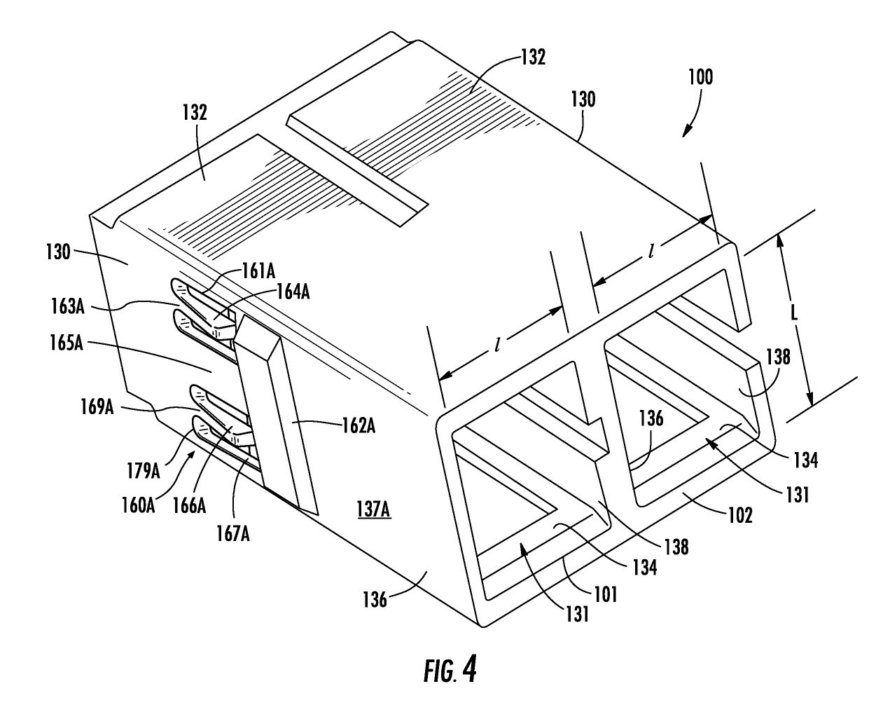

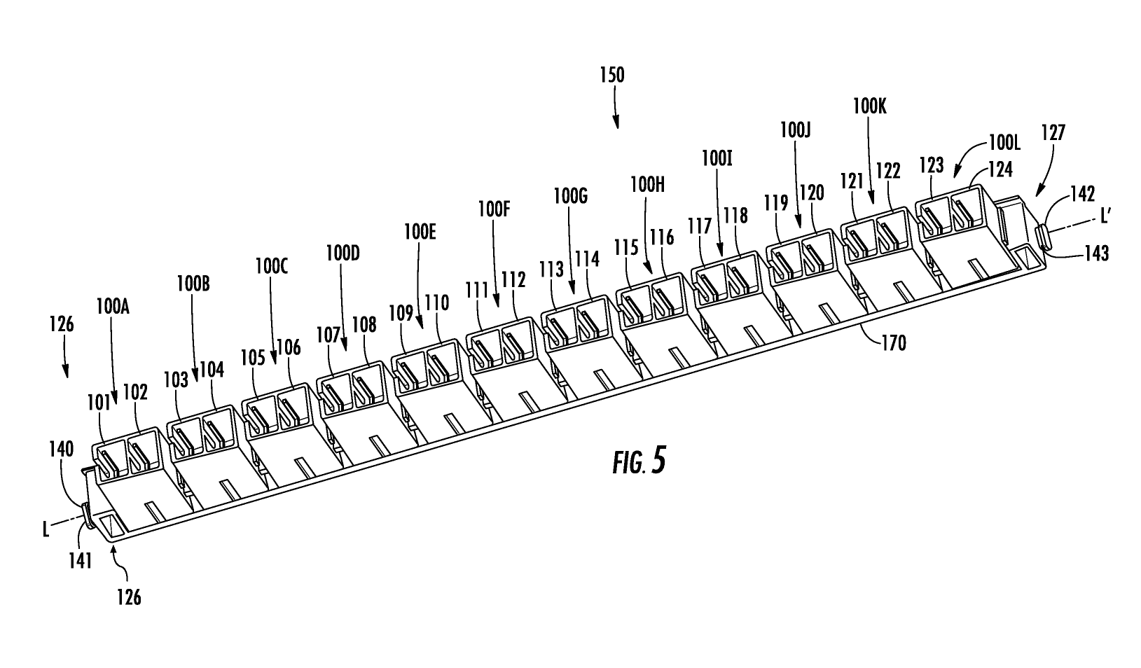

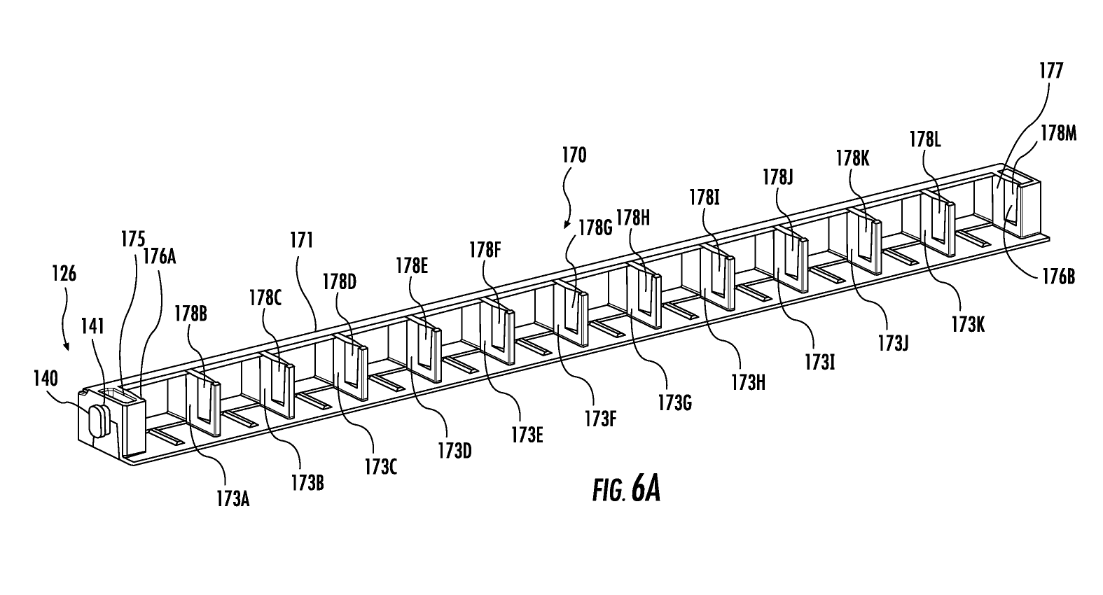

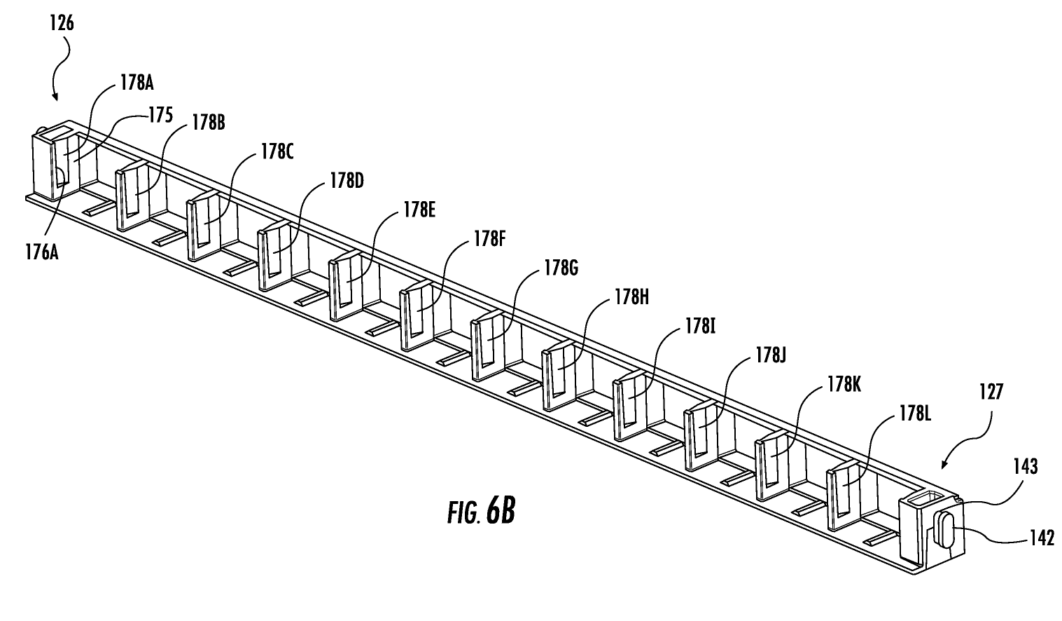

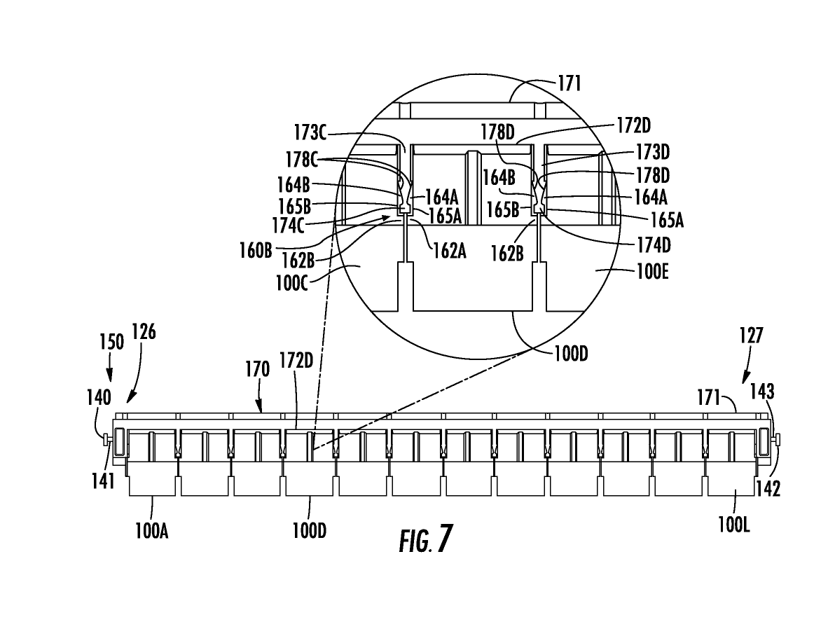

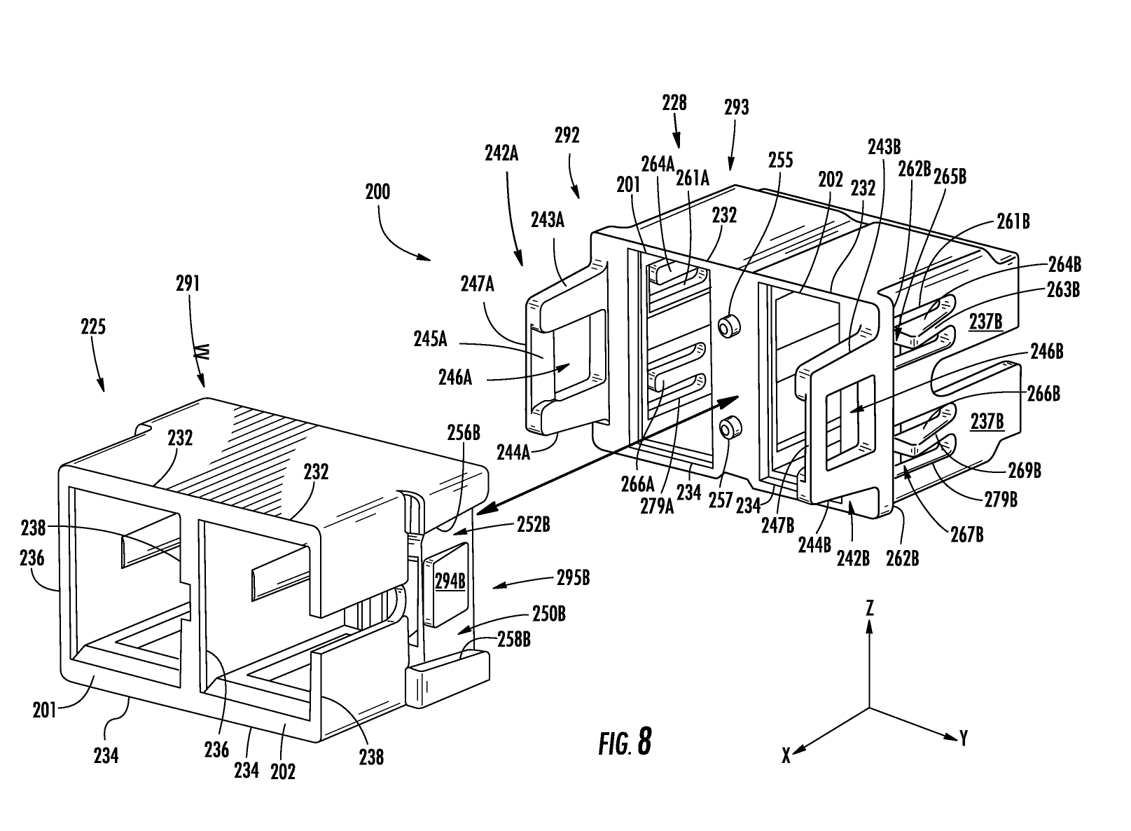

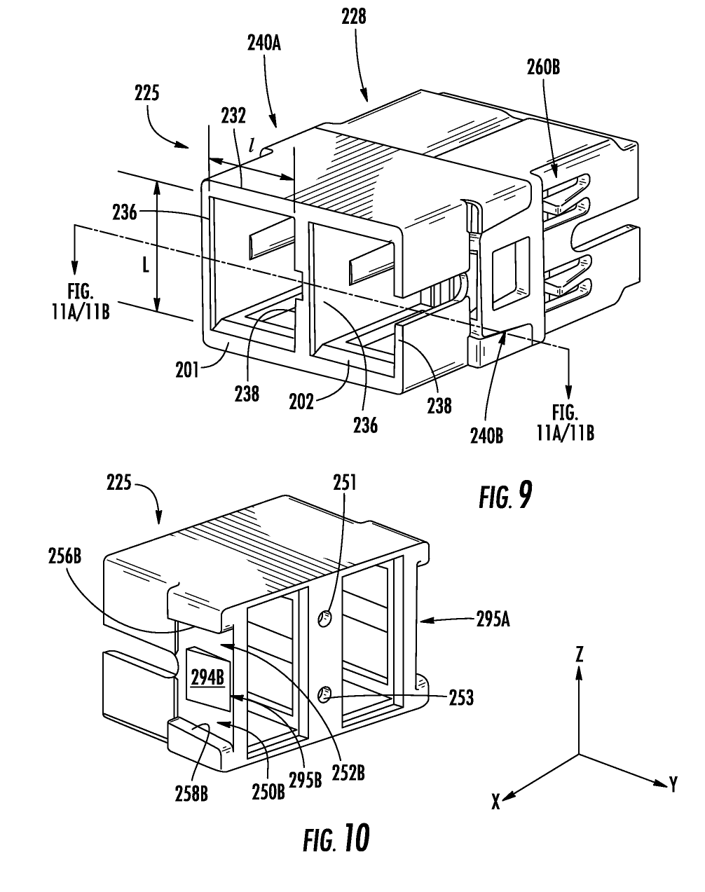

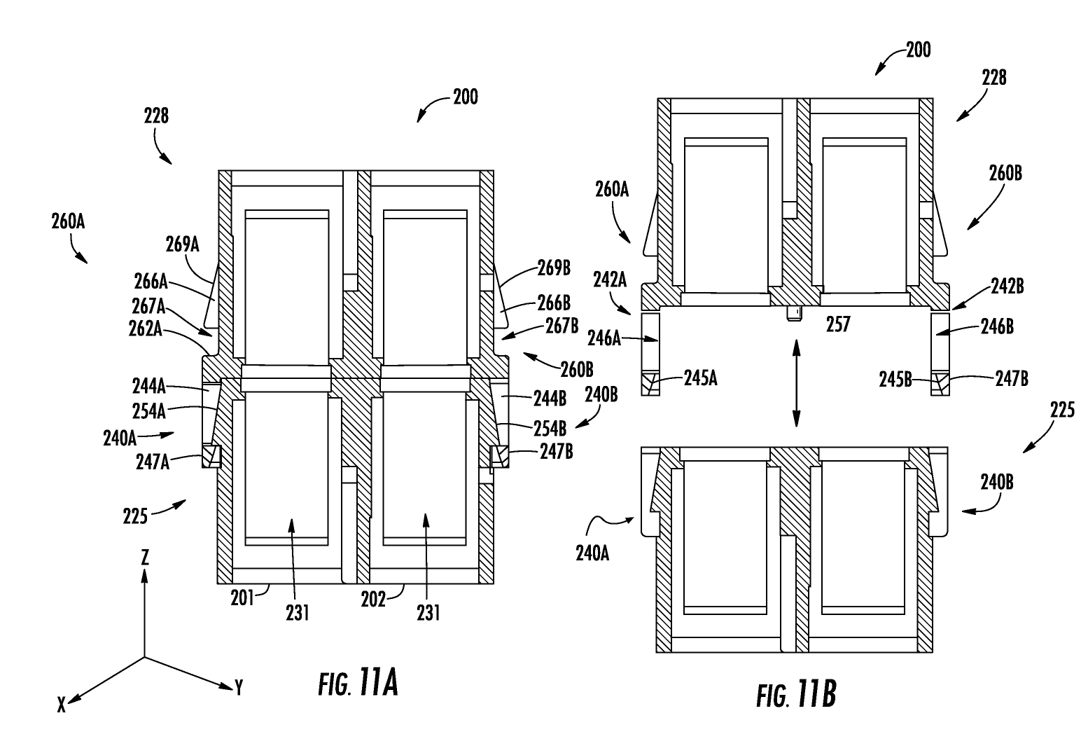

Referring to FIGS. 1-3, an example of a gang fiber adaptor assembly is shown as 10. Gang fiber adaptor assembly 10 includes twenty-four (24) adaptors 1-24 connected together. Adaptor assembly 10 includes a first end 26 and a second end 27 opposite first end 26 along a longitudinal axis L-L′. Adaptor assembly 10 also includes a first face 28 located at first and second ends 26 and 27, respectively, and a second face 29, located at first and second ends 26 and 27, respectively, on a side of adaptor assembly 10 opposite first face 28.

Each adaptor 1-24 is configured to connect to an individual optical fiber by conventional methods. Adaptors 1-24 may accept any conventional optical fiber connector for connecting to optical fibers such as, for example, SC connectors, LC connectors, ST connectors, FC connectors, E2000 connectors, and any other optical fiber connectors. As shown in this example, adaptors 1-24 are SC adaptor connectors. As such, gang fiber adaptor assembly 10 permits 24 optical fibers to be ganged together in one optical fiber cassette 500.

Adaptors 1-24 each have a body 30, wherein body 30 includes a first short side 32, a second short side 34 opposite first short side 32, a first long side 36, a second long side 38 opposite first long side 36, and a channel 31 disposed through body 30 between the four walls. Channel 31 is configured and operable to receive and connect to an optical fiber connector inserted therein. First and second short sides 32 and 34, respectively, have a length (l), and first and second long sides 36 and 38, respectively, have a length (L). Length (L) is greater than length (l).

Adaptors 1-24 are disposed side-by-side along longitudinal axis L-L′ to form gang fiber adaptor assembly 10. As shown, the adaptors are positioned such that the adaptor's long sides are adjacent to each other or connected to each other and are transverse to longitudinal axis L-L′. In this configuration, first and second short sides 32 and 34, respectively, are parallel to longitudinal axis L-L′. For example, a second long side 38 of first adaptor 1 is positioned adjacent to first long side 36 of second adaptor 2. This configuration permits a dense adaptor configuration on the optical fiber cassette 500.

A stem (not shown) extends from a first end 26 of gang fiber adaptor assembly 10 along longitudinal axis L-L′, and a head 40 is positioned on a distal end of the stem and extends transverse to the stem and longitudinal axis. Also, a stem 43 extends from a second end 27 of gang fiber adaptor assembly 10 along longitudinal axis L-L′, opposite first end 26. A head 42 is positioned on a distal end of stem 43 and extends transverse to stem 43 and the longitudinal axis. It is understood that the stem and head 40 extending from first end 26 is the same as stem 43 and head 42. In this example, gang fiber adaptor assembly 10 is molded as an integral piece from a polymer material, composite material, or any combination thereof. An example of a polymer material that may be used is polycarbonate, Ultem. However, it is understood that gang fiber adaptor assembly 10 may be manufactured from one or more pieces that may be connected together using conventional methods such as for example, welding (e.g., hot weld, sonic welds, etc.), snap-fit connections, screws, bolt and nut connections, etc.

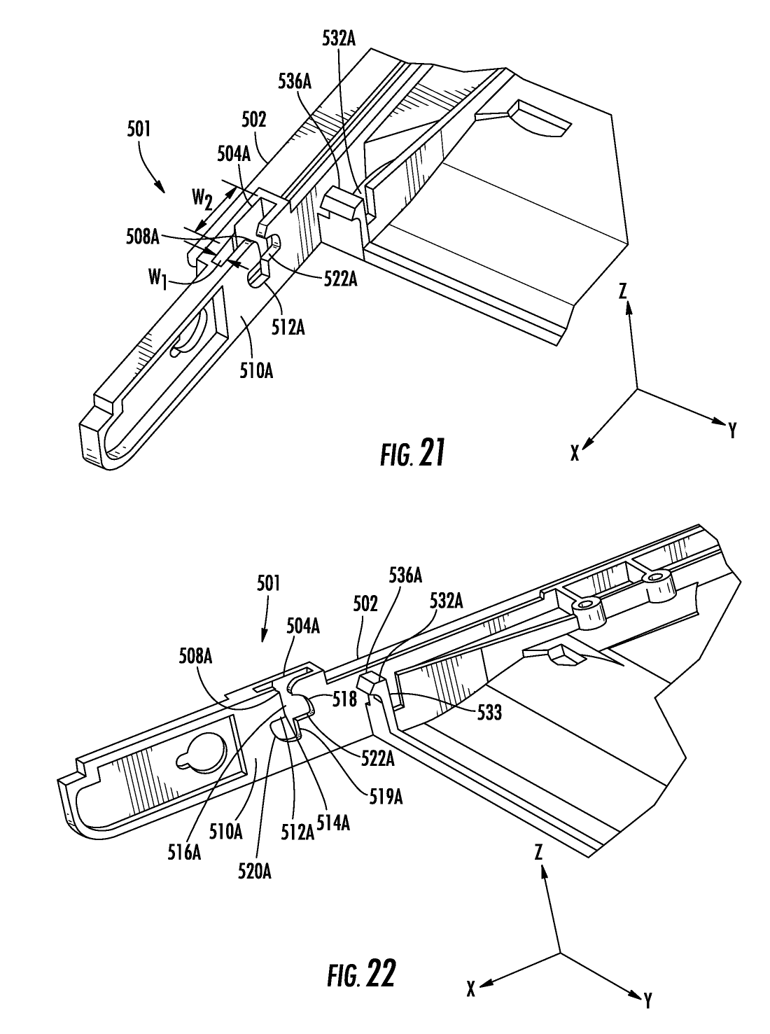

Referring to FIG. 2, gang adaptor assembly 10 may include a first latch actuator 46 at first end 26 and a second latch actuator 48 at second end 27. First and second latch actuators 46 and 48 include respective actuator surfaces 49A/49B which correspond with and engage corresponding latch engagement surfaces (e.g., latch engagement surfaces 534A/534B, FIG. 23) on first and second latch mechanisms 532A/532B located on a cassette 500. In this example, actuator surfaces 49A/49B are arcuate or curved surfaces and the corresponding latch surfaces on the first and second latch mechanisms comprise shapes that correspond to (i.e., are the inverse of) the actuator surfaces 49A/49B. However, it is understood that actuator surfaces 49A/49B may comprise any shape, configuration, angle, or radius of curvature as long as such surface actuates the corresponding latch mechanism to release the adaptor holder or gang fiber adaptor assembly such that it may rotate or tilt within cassette 500 as will be shown and described below herein. In one such alternative example, actuator surfaces 49A/49B may be linear, angled surfaces that engage corresponding linear, angled surfaces of the first and second latch mechanisms on cassette 500.

Also, gang adaptor assembly 10 may include either or both a first stop 50 and a second stop 52 disposed along second face 29 at respective first and second ends 26 and 27. Either or both first stop 50 and second stop 52 may be configured to prevent gang adaptor assembly 10 from rotating or tilting beyond a specific angular rotation, angle α, about longitudinal axis L-L′. In this example, first stop 50 and second stop 52 each comprise a stop oriented at an angle α (e.g., FIG. 34). First and second stop 50 and 52 are configured to prevent gang adaptor assembly 10 from rotating or tilting past angle α (e.g., FIG. 34). Angle α is determined based upon the desired maximum angle of rotation or tilt of gang adaptor assembly 10 about longitudinal axis L-L′. In certain examples, angle α is about 10°, about 15°, about 20°, about 25°, about 30°, about 35°, about 40°, about 45°, about 50°, about 55°, about 60°, about 65°, about 70°, about 75°, about 80°, about 85°, or about 90°. In such embodiment, gang adaptor assembly 10 may rotate or tilt between a starting position angular orientation (e.g., 0°) and angle α. In other embodiments gang adaptor assembly 10 may be configured to rotate or tilt 360° about axis L-L′.

As shown in FIG. 3, gang adaptor assembly 10 may be fixedly, movably, or removably connected to a frame 502 of optical fiber cassette 500 as will be explained below herein. In this example, gang adaptor assembly 10 is rotatably connected to frame 502 such that gang adaptor assembly 10 may rotate or tilt about longitudinal axis L-L′ in a counterclockwise direction A or clockwise direction B. In addition, cassette 500 may be configured to be removably inserted into and connected to a splice connect housing or other optical fiber cassette housings as conventionally known.

Referring to FIG. 4, an example of an adaptor assembly is shown as 100. Adaptor assembly 100 comprises a first adaptor 101 and a second adaptor 102 adjacent to first adaptor 101. In this embodiment, adaptor assembly 100 comprises a body 130 molded as an integral piece from a polymer material, composite material, or any combination thereof. An example of a polymer material that may be used is polycarbonate, Ultem®. It is understood that body 130 may comprise one or more components connected together using any conventional method including, but not limited to hot weld, sonic weld, weld, snap-fit, screws, etc. Additionally, adapter assembly 100 may be referred to as a duplex connector adapter and configured to receive a duplex optical connector.

First adaptor 101 and second adaptor 102 each comprise a first short side 132, a second short side 134, a first long side 136, a second long side 138, and respective channel 131 disposed within body 130 between the pairs of short walls and the pairs of long walls. First and second short sides 132 and 134, respectively, have a length (l), and first and second long sides 136 and 138, respectively, have a length (L). Length (L) is greater than length (l). Channel 131 is configured and operable to receive and connect to an optical fiber connector inserted therein. First and second adaptors 101 and 102 may comprise any optical fiber adaptor, including but not limited to those as shown and described herein. As shown in FIG. 4, second long side 138 of first adaptor 101 is positioned adjacent to and along side of first long side 136 of second adaptor 102.

A first holder connector 160A and a second holder connector 160B of adaptor assembly 100 are operable to connect adaptor assembly 100 to an adaptor holder 170 (FIGS. 6 and 7). First holder connector 160A is positioned along an outside surface 137A of first long side 136 of adaptor assembly 100. Second holder connector (e.g., 160B, FIG. 7) is positioned on an outside surface of second long side 138 of second adaptor 102 that is identical to first holder connector 160. Accordingly, only first holder connector 160A is explained in detail herein. First and second holder connectors 160A and 160B may comprise a variety of conventional or yet-to-be developed connectors capable of fixedly r removably connecting adaptor assemblies 100A-100L to adaptor holder 170, including but not limited to snap-fit connectors, etc. In this example, first holder connector 160A comprises a first abutment 162A, a first opening 161A disposed within surface 137A, a second opening 179A disposed within surface 137A and adjacent to first opening 161A, a first tab 164A adjacent to first abutment 162A and extending cantilevered into first opening 161A, and a second tab 166A adjacent to first abutment 162A and extending cantilevered into second opening 179A.

First tab 164A and second tab 166A are oriented such that they are substantially parallel to each other along surface 137A and are positioned adjacent to first abutment 162A. First tab 164A is positioned adjacent to first abutment 162A such that a first channel 165A is formed in the space between first abutment 162A and first tab 164A. Second tab 166A is positioned adjacent to first abutment 162A such that a second channel 167A is formed in the space between first abutment 162A and second tab 166A. Additionally, first tab 164A may comprise an incline or cam surface 163A that extends outwardly from surface 137A. Similarly, second tab 166A may comprise an incline or cam surface 169A that extends outwardly from surface 137A.

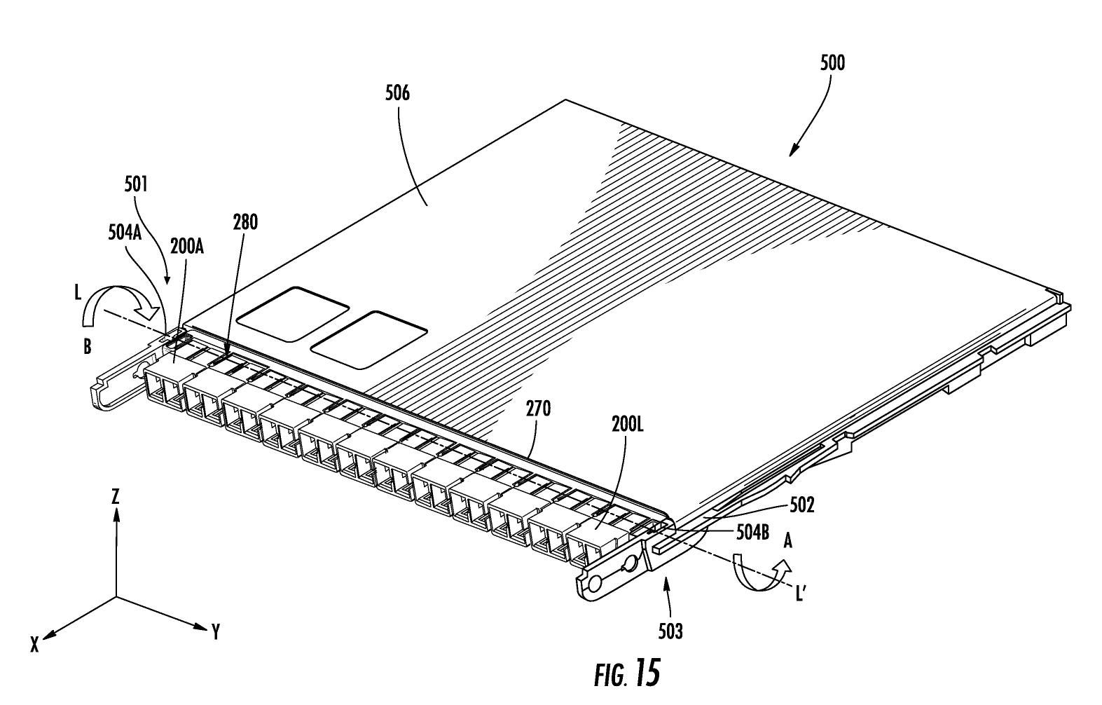

Referring to FIGS. 5-7, another example of a gang fiber adaptor assembly is shown as 150. Gang fiber adaptor assembly 150 may comprise a plurality of adaptor assemblies 100 (e.g., adaptor assemblies 100A-100L). In this example, gang fiber adaptor assembly 150 comprises an adaptor holder 170 for receiving and connecting to twelve (12) adaptor assemblies 100A-100L, which comprises twenty-four (24) adaptors 101-124. Adaptor holder 170 may connect fixedly, movably, or removably to a frame of an optical fiber cassette (e.g., frame 502 of cassette 500 shown in FIG. 3 or frame 502 of cassette 500 shown in FIG. 14).

A stem 141 extends from a first end 126 of gang fiber adaptor assembly 150 along longitudinal axis L-L′, and a head 140 is positioned on a distal end of the stem and extends transverse to stem 141 and longitudinal axis. Also, a stem 143 extends from a second end 127 of gang fiber adaptor assembly 150 along longitudinal axis L-L′, opposite first end 126. A head 142 is positioned on a distal end of stem 143 and extends transverse to stem 143 and the longitudinal axis. In this example, gang fiber adaptor assembly 150 comprises multiple separate components such as, for example, adaptor holder 170 and the plurality of adaptor assemblies 100A-100L, but could be molded as an integral piece from a polymer material, composite material, or any combination thereof. An example of a polymer material that may be used is polycarbonate, Ultem. Such an embodiment can be the same as or similar to the embodiment shown and described in FIGS. 1-2 described above herein.

Holder 170 may further comprise a framework 171 and a plurality of dividers 173A-173K extending from the framework for dividing framework 171 into a plurality of adaptor assembly receptacles 172A-172L. In this example, dividers 173A-173K extend from framework 171 in a cantilevered orientation. A pair of indentations 178 (e.g., 178B-178L) are disposed within opposite sides of each of dividers 173A-173K, adjacent the distal ends of each divider 173A-173K, to form a divider head 174A-174K as shown in detail in FIGS. 6 and 7. Divider head 174A-174K may be a flanged end in certain embodiments. Holder 170 further comprises at first end 126 a first end wall 175 and at second end 127 a second end wall 177. First end wall 175 may comprise an indentation 178A (which may be the same as or similar to indentations 178B-178L) disposed therein to form a holder end head 176. Second end wall 177 may comprise an indentation 178M (which may be the same as or similar to indentations 178B-178L or indentation 178A) disposed therein to form a holder end head 176. Holder end heads 176 may be flanged ends in certain embodiments.

When an adaptor assembly (e.g., 100A-100L) is inserted into an adaptor receptacle 172A-172L, either a pair of divider heads (e.g., 174A-174K) engage and connect to first and second connectors 160A and 160B or a divider head (e.g., 174A or 174K) and a holder end head 176 engage and connect to first and second connectors 160A and 160B, depending upon which adaptor receptacle the adaptor assembly is inserted therein. Referring to FIG. 7, for example, when adaptor assembly 100D is inserted into adaptor receptacle 172D, divider head 174C engages cam surfaces 163A and 169A of respective first and second tabs 164A and 166A, pushing tabs 164A and 166A inwardly toward adaptor assembly 100D, permitting divider head 174C to move past the tabs and into first and second channels 165A and 167A. Additionally, once the divider head 174C has moved past first and second tabs 164A and 166A, the tabs move, flex or snap back outwardly into indentation 178C disposed in the corresponding side of divider 173C.

Simultaneously, divider head 174D engages cam surfaces 163B and 169B of respective first and second tabs 164B and 166B positioned on the opposite side of adaptor assembly 100D, pushing tabs 164B and 166B inwardly toward adaptor assembly 100D, permitting divider head 174D to move past the tabs and into first and second channels 165B and 167B. Additionally, once the divider head 174D has moved past first and second tabs 164B and 166B, the tabs move, flex or snap back outwardly into indentation 178D disposed in the corresponding side of divider 173D. When tabs 164A/B and 166A/B located on both sides of adaptor assembly 100D are within respective indentations 178C and 178D, adaptor assembly 100D is locked into its position on adaptor holder 170. As such, adaptor assembly 100D is connected to, locked into, or “snapped” into holder 170. The adaptor assembly 100D will not come out of adaptor receptacle 172D unless a force is applied to adaptor assembly 100D sufficient enough to move or push first and second tabs 164A/B and 166A/B on both sides of adaptor assembly 100D inwardly out of and away from respective indentations 178C and 178D sufficient enough to permit respective divider heads 174C and 174D to move past first and second tabs 164A/B and 166A/B. This operation is the same for all the adaptor assemblies 100B-100K when they are inserted into their respective adaptor receptacles 172B-172K.

Referring to FIGS. 8-11B, another example of an adaptor assembly is shown as 200. Adaptor assembly 200 comprises a first portion 225 and a second portion 228 which is removably connectable to first portion 225. When first portion 225 is connected to second portion 228, adaptor assembly 200 forms two adaptors: a first adaptor 201 and a second adaptor 202 adjacent to and integral with first adaptor 201. First portion 225 optionally includes a first locking pin receiver 251 and a second locking pin receiver 253 disposed on a surface of first portion 225 as shown in FIG. 10. Correspondingly, second portion 228 optionally includes a first locking pin 255 and a second locking pin 257 extending from a surface of second portion 228 as shown in FIG. 8. When the two portions 225 and 228 are brought together to connect to one another, first locking pin 255 inserts into first locking pin receiver 251 and second locking pin 257 inserts into second locking pin receiver 253.

First adaptor 201 includes a body 230 having a first short side 232, a second short side 234 opposite first short side 232, a first long side 236, a second long side 238 opposite first long side 236, and a first adaptor channel 231 disposed therein and between the four (4) sides. Similarly, second adaptor 202 includes a first short side 232, a second short side 234 opposite first short side 232, a first long side 236, a second long side 238 opposite first long side 236, and a second adaptor channel 231 disposed therein and between the four (4) sides. First and second adaptor channels 231 are configured and operable to receive and connect to an optical fiber connector. First and second short sides 232 and 234, respectively, have a length (l), and first and second long sides 236 and 238, respectively, have a length (L) as shown in FIG. 10. Length (L) is greater than length (l). In this configuration, second long side 238 of first adaptor 201 is positioned alongside and adjacent to first long side 236 of second adaptor 202.

Adaptor assembly 200 includes a first adaptor assembly connector 240A and a second adaptor assembly connector 240B positioned on a side opposite first adaptor assembly connector 240A for connecting (i.e., removably connecting such as, for example, a snap-fit connection) first portion 225 and second portion 228 together. First adaptor assembly connector 240A comprises a first adaptor tongue 242A and a first tongue receiver 295A operable to receive and connect to first adaptor tongue 242A. Second adaptor assembly connector 240B comprises a second adaptor tongue 242B and a second tongue receiver 295B operable to receive and connect to second adaptor tongue 242B. First and second adaptor assembly connectors 240A and 240B include the same components. As such, the adaptor assembly connectors will be explained with reference to second adaptor assembly connector 240B. Second tongue receiver 295B of second adaptor assembly 240B comprises a protrusion 254B that includes an inclined surface 294B, a first angled wall 256B extending perpendicular from second long side 238, and a second angled wall 258B extending perpendicular from second long side 238 located on a second end 291 of first portion 225. A first side of protrusion 254B and first angled wall 256B form a first wedge channel 250B that narrows in its width along the length of the channel from a second end 291 of first portion 225 toward a first end 290. A second side of protrusion 254B, opposite the first side, and second angle wall 258B form a second wedge channel 252B that also narrows in its width along the length of the channel from second end 291 toward first end 290. First and second wedge channels 250A and 258A also narrow in width along the length of the channels from second end 291 to first end 290.

Adaptor assembly connector 240B further comprises a second tongue 242B that corresponds to, insert into and connects to second tongue receiver 295B. Second tongue 242B comprises a first extension 243B, a second extension 244B, a cross member 247B connecting first and second extensions 242B and 243B, respectively, and a second tongue aperture 246B. Cross member 247B includes an angled surface 245B. First and second extensions 243B and 244B of second tongue 242B are wedge shaped such that an of the extension that is proximal to second portion 228 is wider than an end of the extensions that is distal to second portion 228, thus forming a wedge-shape that corresponds to the wedge-shape of respective first and second wedge channels 252B and 258B.

When first portion 225 is brought together and aligned with second portion 228, first tongue 242A is aligned with, inserted into, and then connects with first tongue receiver 295A, and second tongue 242B is aligned with, inserted into, and then connects with second tongue receiver 295B. In particular, when first portion 225 is brought together with second portion 228, first extension 243B inserts into second wedge channel 252B, second extension 244B inserts into first wedge channel 250B, and second angled surface 245B (not shown) engages against second inclined surface 294B of second protrusion 254B, causing second adaptor tongue 242B to slightly flare outwardly until second protrusion 254B inserts into second tongue aperture 246B (e.g., snaps into aperture 246B). Additionally, when first and second tongues 242A and 242B are inserted into respective first and second tongue receivers 295A and 295B, respective first and second extensions 243A/243B and 244A/244B insert into and create a friction fit with respective first and second wedge channels 252A/252B and 258A/258B. The operation of first tongue 242A and first tongue receiver 295A of first adaptor assembly connector 240A is the same as just explained for second adaptor assembly connector 240B.

First portion 225 and second portion 228 may be separated when a force is applied to separating the two portions sufficient enough to cause the two tongues 242A and 242B to flare slightly outward such that the movement ejects respective first and second protrusions 254A and 254B from respective first and second tongue apertures 246A and 246B, thus permitting the two portions 225 and 228 to separate.

Referring to FIGS. 8-14, second portion 228 also includes a first holder connector 260A and a second holder connector 260B on a side opposite first holder connector 260A, both of which are operable to connect adaptor assembly 200 (e.g., each adaptor assembly 200A-200L) to an adaptor holder 270. First holder connector 260A is positioned along an outside surface (not visible) of first long side 236 of first adaptor 201. Second holder connector 260B is positioned on an outside surface 237B of second long side 238 of second adaptor 202. First and second holder connectors are identical to each other and to first and second holder connectors 160A and 160B shown in FIG. 4. Accordingly, only second connector 260B is explained in detail herein. First and second connectors may comprise a variety of conventional or yet-to-be developed connectors capable of fixedly or removably connecting adaptor assemblies 200A-200L to adaptor holder 270, including but not limited to snap-fit connectors, etc. In this example, second connector 260B comprises a second abutment 262B, a first opening 261B disposed within surface 237B, a second opening 279B disposed within surface 237B and adjacent to first opening 261B, a first tab 264B adjacent to second abutment 262B and extending cantilevered into first opening 261B, and a second tab 266B adjacent to second abutment 262B and extending cantilevered into second opening 279B.

First tab 264B and second tab 266B are oriented such that they are substantially parallel to each other along surface 237B and are positioned adjacent to second abutment 262B. First tab 264B is positioned adjacent to second abutment 262B such that a first channel 265B is formed in the space between second abutment 262B and first tab 264B. Second tab 266B is positioned adjacent to second abutment 262B such that a second channel 267B is formed in the space between second abutment 262B and second tab 266B. Additionally, first tab 264B may comprise an incline or cam surface 263B that extends outwardly from surface 237B. Similarly, second tab 266B may comprise an incline or cam surface 269B that extends outwardly from surface 237B.

As shown in FIGS. 13 and 14, another example of a gang fiber adaptor assembly is shown as 280. Gang fiber adaptor assembly 280 may comprise a plurality of adaptor assemblies 200 (e.g., adaptor assemblies 200A-200L). In this example, gang fiber adaptor assembly 280 comprises an adaptor holder 270 for receiving and connecting to twelve (12) adaptor assemblies 200A-200L, which comprises twenty-four (24) adaptors 201-224. Adaptor holder 270 may connect fixedly, movably, or removably to a frame of an optical fiber cassette (e.g., frame 502 of cassette 500 shown in FIG. 3 or frame 502 of cassette 500 shown in FIG. 14).

A stem 241 extends from a first end 226 of gang fiber adaptor assembly 280 along longitudinal axis L-L′, and a head 240 is positioned on a distal end of the stem and extends transverse to stem 241 and longitudinal axis. Also, a stem 243 extends from a second end 227 of gang fiber adaptor assembly 280 along longitudinal axis L-L′, opposite first end 226. A head 242 is positioned on a distal end of stem 243 and extends transverse to stem 243 and the longitudinal axis. In this example, gang fiber adaptor assembly 280 comprises multiple separate components such as, for example, adaptor holder 270 and the plurality of adaptor assemblies 200A-200L, but could be molded as an integral piece from a polymer material, composite material, or any combination thereof. An example of a polymer material that may be used is polycarbonate, Ultem. An example of a polymer material that may be used is polycarbonate, Ultem. Such an embodiment can be the same as or similar to the embodiment shown and described in FIGS. 1-2 described above herein.

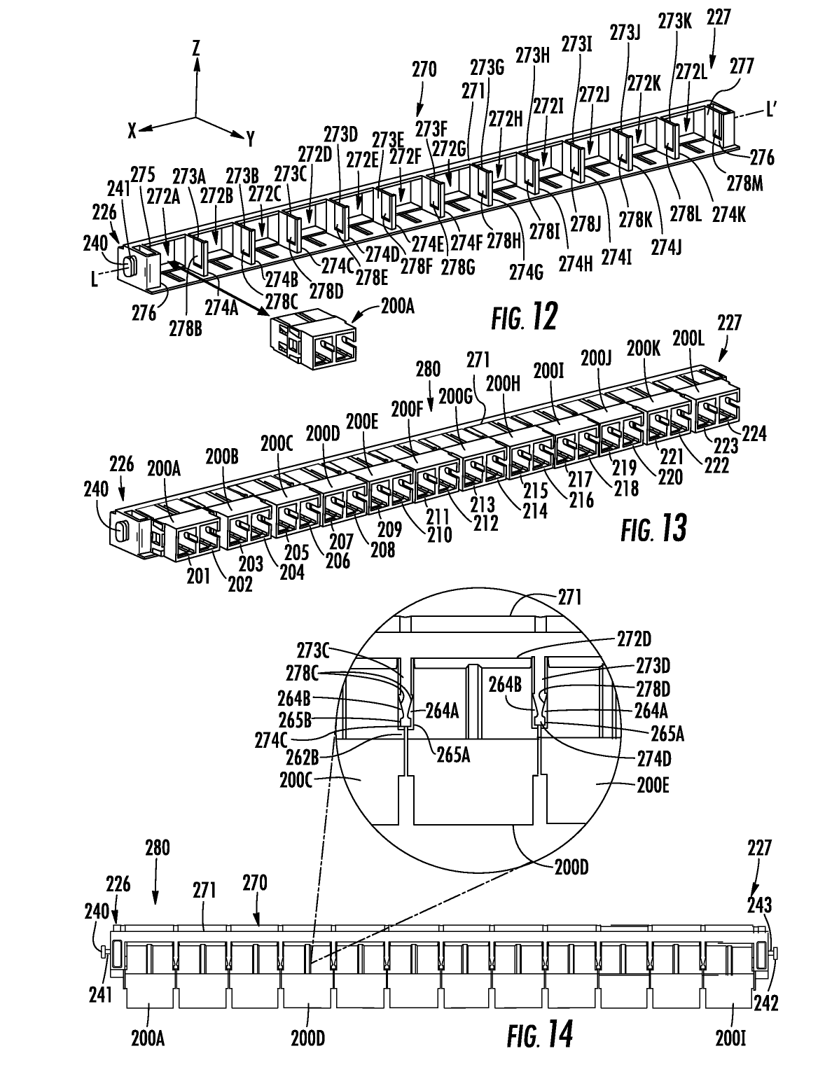

Holder 270 may further comprise a framework 271 and a plurality of dividers 273A-273K extending from the framework for dividing framework 271 into a plurality of adaptor assembly receptacles 272A-272L. In this example, dividers 273A-273K extend from framework 271 in a cantilevered orientation. A pair of indentations 278 (e.g., 278A-278K) are disposed within opposite sides of each of dividers 273A-273K, adjacent the distal ends of each divider 273A-273K, to form a divider head 274A-274K as shown in detail in FIGS. 12, 13, and 14. Divider head 274A-274K may be a flanged end in certain embodiments. Holder 270 further comprises at first end 226 a first end wall 275 and at second end 227 a second end wall 277. First end wall 275 may comprise an indentation (not shown, but is the same as or similar to indentations 278B-278M) disposed therein to form a holder end head 276. Second end wall 277 may comprise an indentation 278M disposed therein to form a holder end head 276. Holder end heads 276 may be flanged ends in certain embodiments. The connection of adaptor assemblies 200A-200L to holder 270 operates the same as the connection of adaptor assemblies 100A-100L to holder 170 shown in FIGS. 4-7 and described above herein, such description is herein incorporated by reference and thus will not be repeated herein.

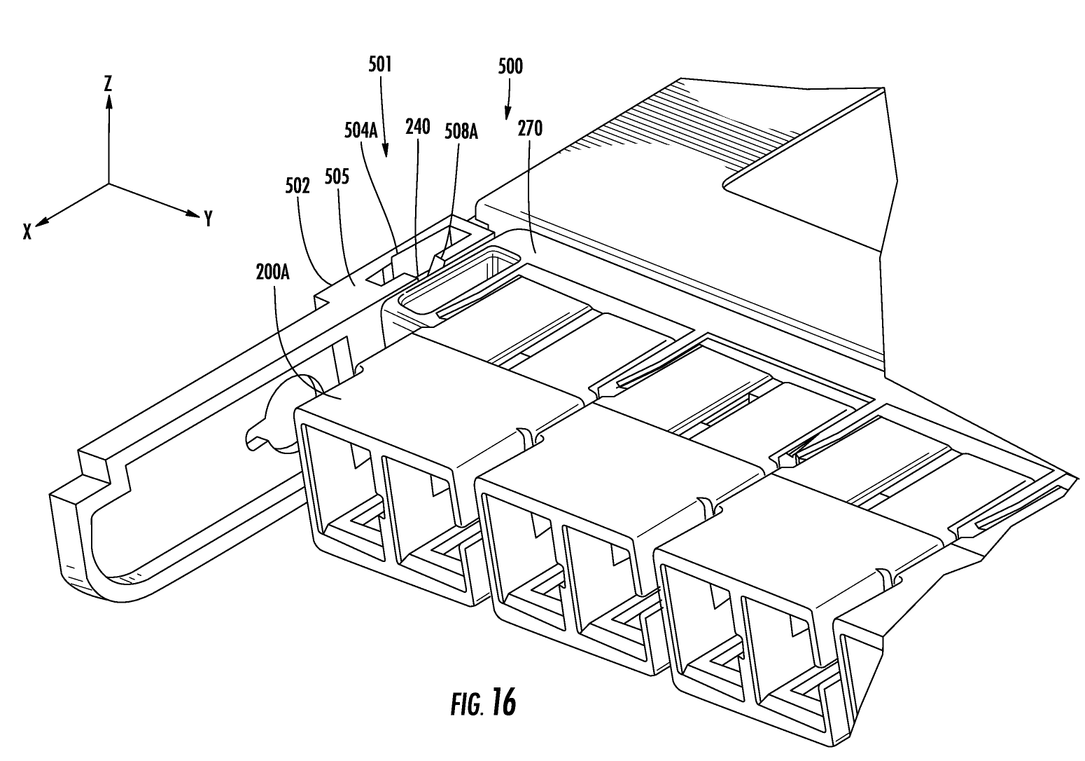

Referring to FIGS. 15-16, gang fiber adaptor assembly 280 is shown attached to an illustrative cassette 500. Cassette 500 includes a framework 502 operable for receiving, routing and storing optical fibers and optical fiber connections within a facility such as a cabinet. Cassette 500 is operable to slide into and out of a fiber optic distribution frames or cabinets. Framework 502 includes a first head slot 504A disposed within framework 502 at a first framework side 501 of framework 502 to receive head 240 and stem 241 located at first end 226 of gang fiber adaptor assembly 280. Additionally, framework 502 includes a second head slot 504B disposed within framework 502 at a second framework side 503 of framework 502 to receive head 242 and stem 243 located at second end 227 of gang fiber adaptor assembly 280. The above described connection points between the gang fiber adaptor assembly 280 and cassette 500 permit gang fiber adaptor assembly 280 to rotate or tilt in a counter-clockwise direction A or a clockwise direction B about an axis L-L′ as will be described in greater detail below.

Referring specifically to FIG. 16, first head slot 504A is disposed within a top surface 505 of framework 502 and oriented along the reference, X-axis and includes a certain depth within framework 502 along the reference, Z-axis. First Head slot 504A also includes a first stem slot 508A to receive stem 241 of gang fiber adaptor assembly 280 which will be shown and described later herein. At second end 503 of framework 502, second head slot 504B is orientated the same as or similar to first head slot 504B and includes a second stem slot 508B the same as or similar to first stem slot 508A as shown and described above herein.

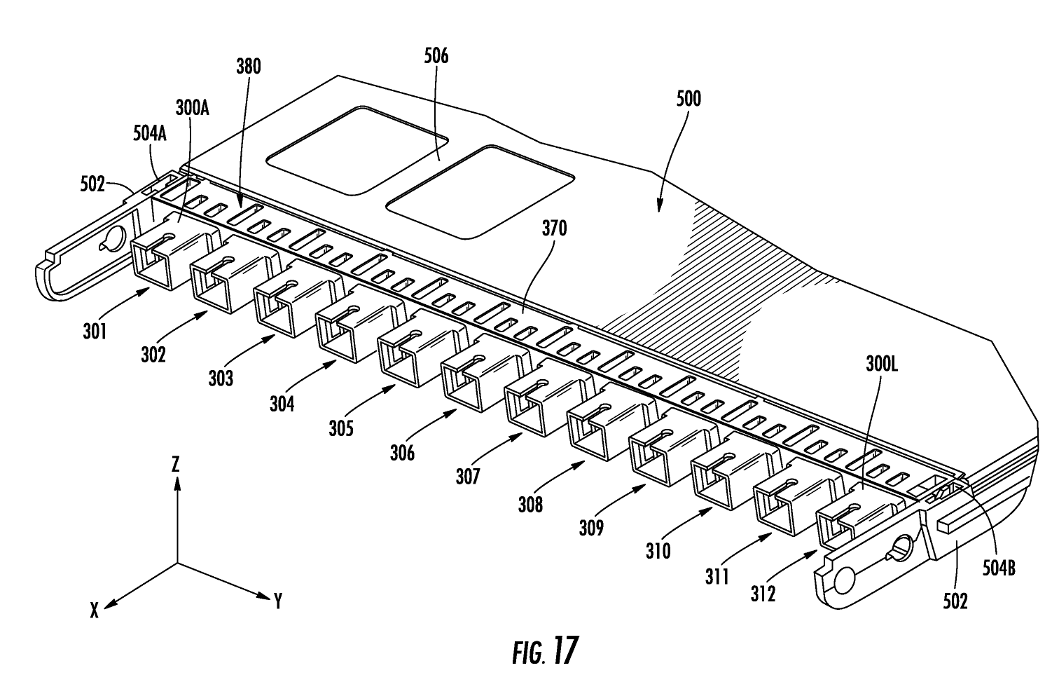

In the example shown in FIGS. 15-16, gang fiber assembly 280 includes 24 SC adaptor connectors 201-224. However, a variety of designs, adaptor connectors and configurations may be used with the rotatable connection as shown and described herein. As such, any type and number of adaptor connectors may be ganged and connected to a cassette using the rotatable connection as shown and described herein, examples of which are shown in FIGS. 17-19. For example, FIG. 17 shows a gang fiber adaptor assembly 380 comprising twelve (12) SC adaptor connectors 301-312 removably connected to an adaptor holder 370. Adaptors 301-312 may be connected to adaptor holder 370 using any conventional or yet-to-be developed connections, including but not limited to snap-fit connections and those connection examples shown and described herein. Also, adaptor holder 370 comprises a first and second stems (e.g., stems 241 and 243) extending from opposite ends of adaptor holder 370 along a longitudinal axis (e.g., axis L-L′) of adaptor holder 370 and first and second heads (e.g., heads 240 and 242) disposed on distal ends of the stems as shown and described above herein with reference to the other examples (e.g., as shown in FIGS. 1-14). Similar to the other examples described herein, the first and second heads and stems are inserted into respective first head slot 504A and stem slot 508A and second head slot 504B and stem slot 508B in order to rotatably connect gang fiber adaptor assembly 380 to cassette 500.

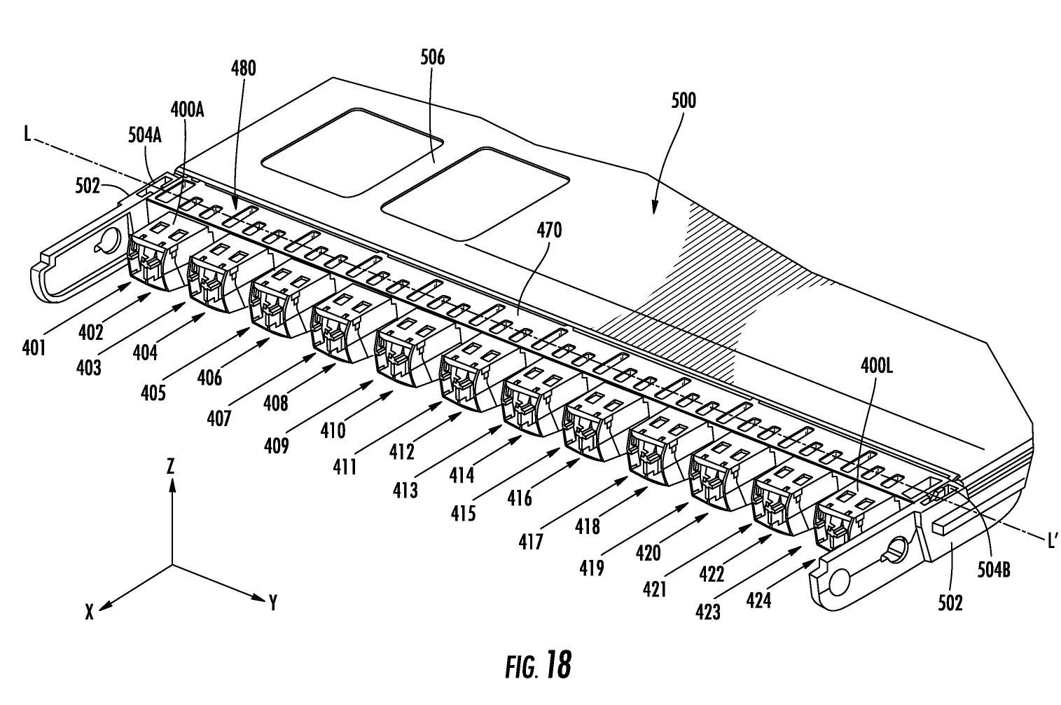

As another example, FIG. 18 shows a gang fiber adaptor assembly 480 comprising twelve (12) adaptor assemblies 400A-400L comprising twenty-four (24) LC adaptor connectors 401-424. Adaptors assemblies 400A-400L may be connected to adaptor holder 470 using any conventional or yet-to-be developed connections, including but not limited to snap-fit connections and those connection examples shown and described herein. Also, adaptor holder 470 comprises a first and second stems (e.g., stems 241 and 243) extending from opposite ends of adaptor holder 470 along a longitudinal axis (e.g., axis L-L′) of adaptor holder 470 and first and second heads (e.g., heads 240 and 242) disposed on distal ends of the stems as shown and described above herein with reference to the other examples (e.g., as shown in FIGS. 1-14). Similar to the other examples described herein, the first and second heads and stems are inserted into respective first head slot 504A and stem slot 508A and second head slot 504B and stem slot 508B in order to rotatably connect gang fiber adaptor assembly 480 to cassette 500.

As yet another example, FIG. 19 shows a gang fiber adaptor assembly 680 comprising eighteen (18) adaptor assemblies 600A-600L comprising thirty-six (36) LC adaptor connectors 601-636. Adaptor assemblies 600A-600L may be removably connected to an adaptor holder 670 using any conventional or yet-to-be developed connections, including but not limited to snap-fit connections and those connection examples shown and described herein. Also, adaptor holder 670 comprises a first and second stems (e.g., stems 241 and 243) extending from opposite ends of adaptor holder 670 along a longitudinal axis (e.g., axis L-L′) of adaptor holder 670 and first and second heads (e.g., heads 240 and 242) disposed on distal ends of the stems as shown and described above herein with reference to the other examples (e.g., as shown in FIGS. 1-14). Similar to the other examples described herein, the first and second heads and stems are inserted into respective first head slot 504A and stem slot 508A and second head slot 504B and stem slot 508B in order to rotatably connect gang fiber adaptor assembly 680 to cassette 500.

Although not shown or described above, gang adaptor assemblies 150, 280, 380, and 480 may include a first latch actuator disposed at first end (e.g., 126, 226, 326, 426) of the gang adaptor assembly and a second latch actuator disposed at second end (e.g., 127, 227, 327, 427) similar to what is shown in, for example, FIGS. 1, 2, 20, 24, 25, and 28. In addition and although not shown, gang adaptor assemblies 150, 280, 380, and 480 may include a first stop disposed at respective first end (e.g., 126, 226, 326, 426) and a second stop disposed at respective second ends (e.g., 127, 227, 327, 427). Either or both the first stop and second stop may be configured to prevent gang adaptor assembly (e.g., 150, 280, 380, and 480) from rotating or tilting beyond a specific angular rotation, angle α, about longitudinal axis L-L′. Gang adaptor assemblies 150, 280, 380, and 480 and their respective first and second stops may be configured to provide the same as or similar angle α of rotation or tilt as gang adaptor assembly 10 above.

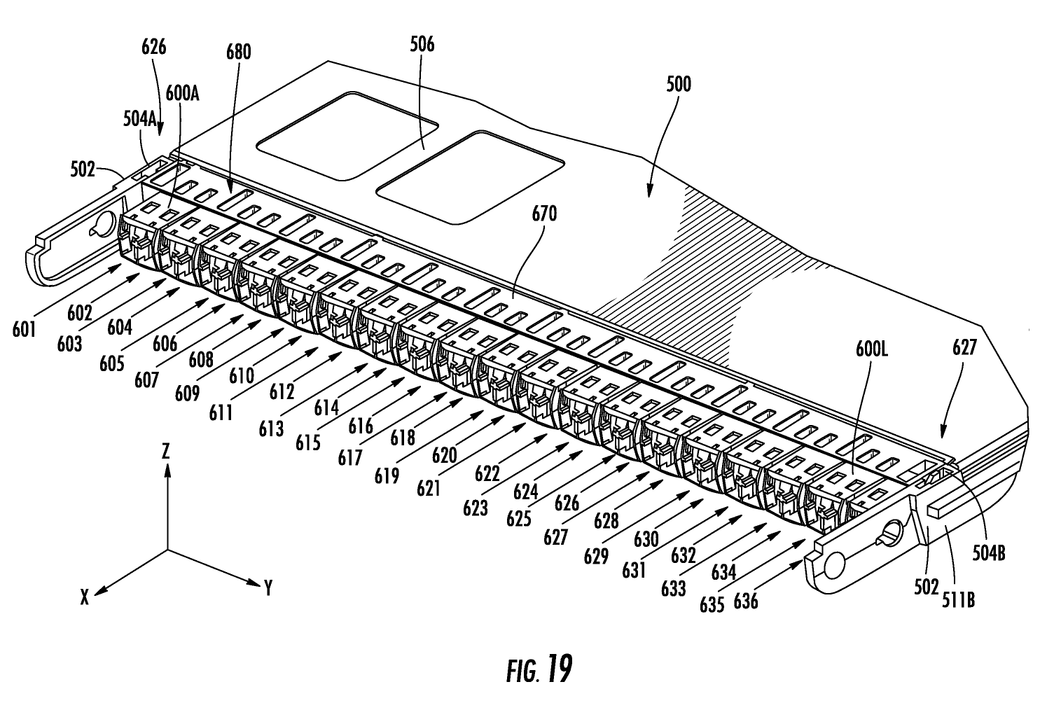

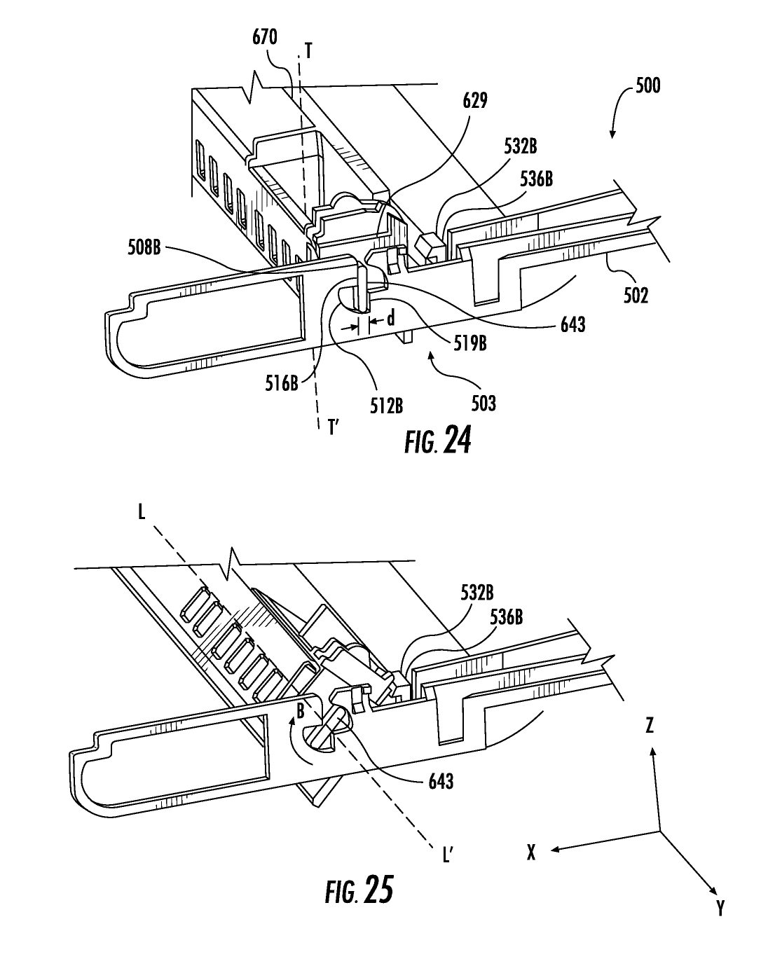

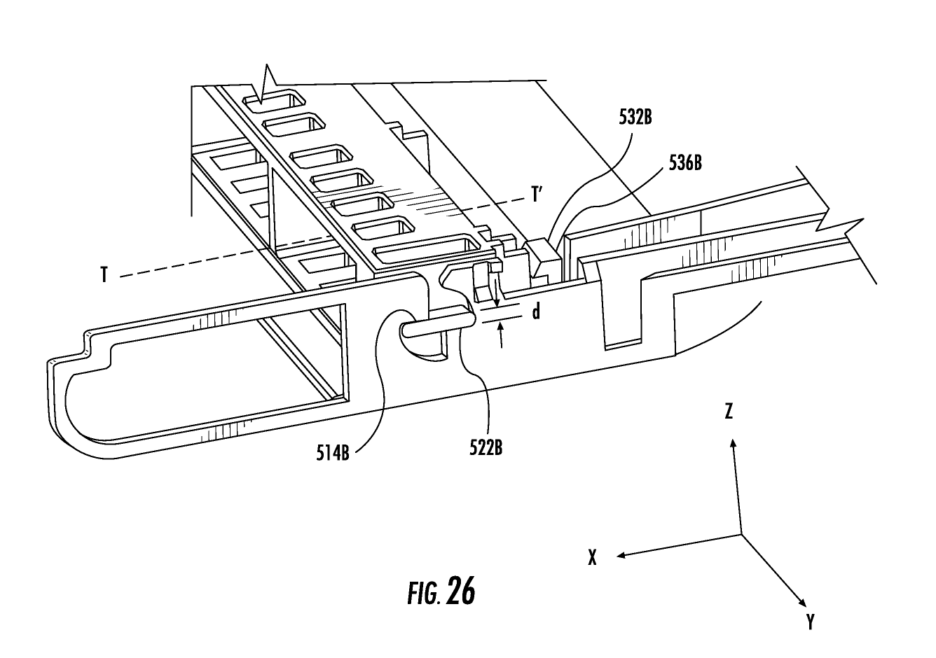

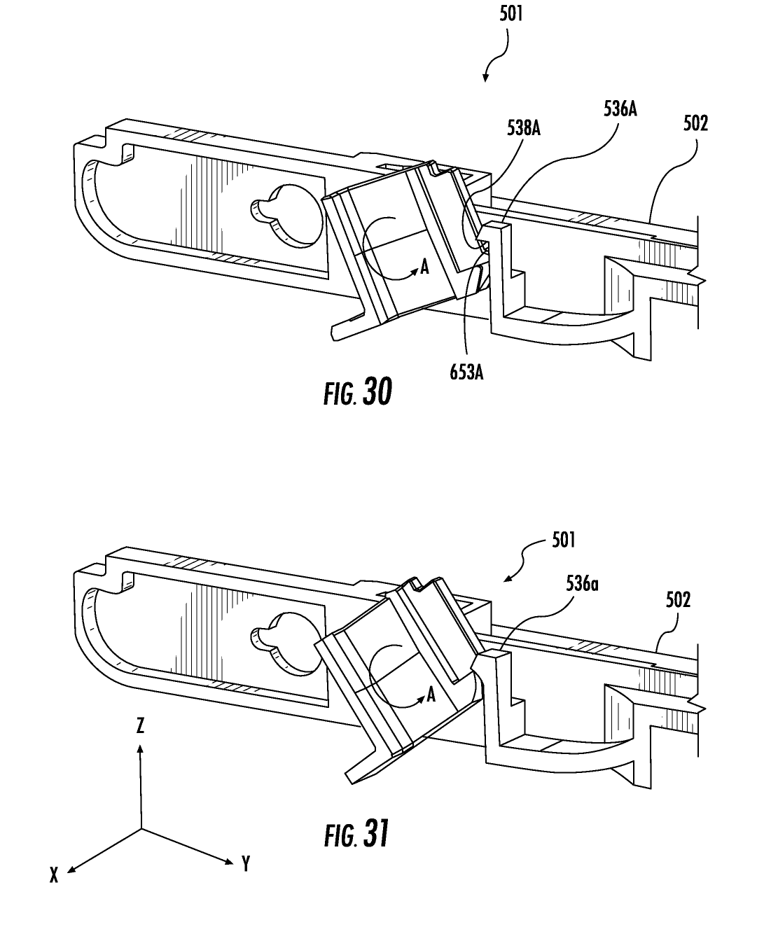

Referring to FIGS. 19-34, a rotatable connection of gang adaptor assembly 680 to cassette 500 is shown and described below herein for illustration purposes only, and not limitation. This connection can be used for any of the other examples of gang adaptor assemblies (e.g., 10, 150, 280, 380, and 480) shown and described herein as well as any other gang adaptor assembles. As shown in FIG. 19, gang adaptor assembly 680 includes a first end 626 and a second end 627 opposite first end 626. Gang adaptor assembly 680, via adaptor holder 670, is rotatably or tiltably connected to framework 502 of cassette 500. Referring specifically to FIG. 20, gang adaptor assembly 680 is shown with adaptor assemblies 600A-600L removed or disconnected from adaptor holder 670. In addition, only second end 627 of holder 670 is shown. As shown, a stem 643 extends from second end 627 along longitudinal axis L-L′ and includes a head 642 disposed on a distal end of stem 643. Stem 643 includes a first dimension (D) that has a certain length and a second dimension (d) (FIG. 25), wherein dimension (D) is greater than dimension (d). In another example, dimension (D) is twice the length of dimension (d). In another example, dimension (D) is three times as long as dimension (d). In yet another example, dimension (D) is four times the length of dimension (d). Although not shown in FIGS. 19 and 20, adaptor holder 670 also includes another stem that is the same as stem 643, except that it extends from first end 626 in the opposite direction along longitudinal axis L-L′ from stem 643. This stem at first end 626, just as stem 642 does, includes a head (not shown) disposed on a distal end of the stem that is the same as head 642.

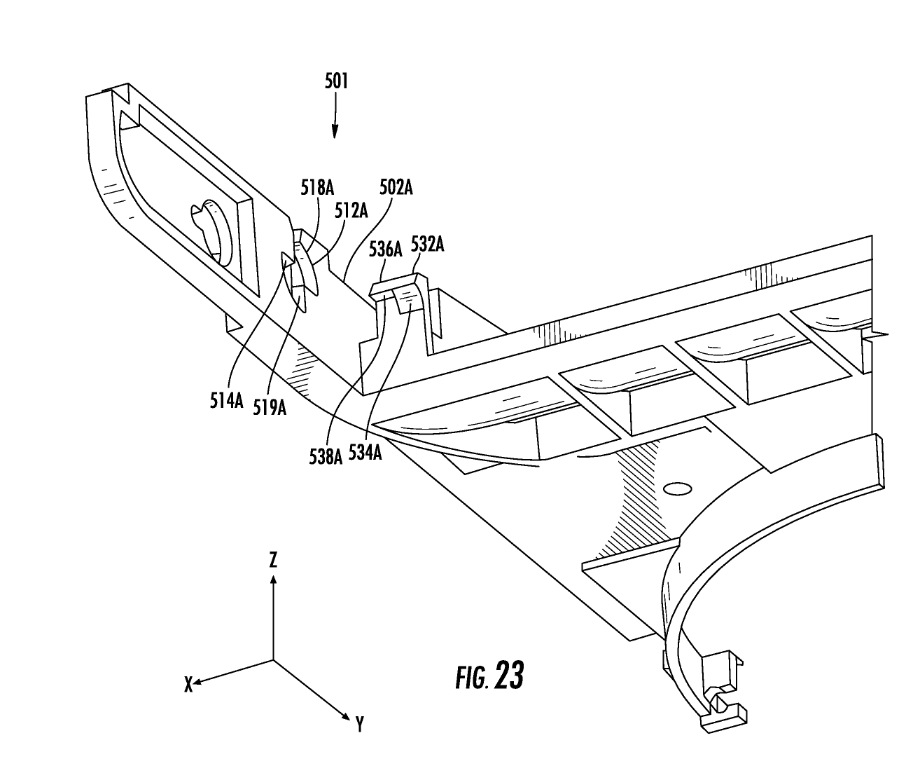

Adaptor holder 670 also includes a first latch actuator 648A (not shown, but the same as second latch actuator 648B) disposed at first end 626 and a second latch actuator 648B disposed at second end 627. First latch actuator is the same as second latch actuator. As such, the latch actuators will be described with reference to second latch actuator 648B. Second latch actuator 648B includes an actuator surface 649B which corresponds with and engages a corresponding second latch surface 534B (not shown but is the same as latch surface 534A shown in FIG. 23) disposed on second latch mechanism 532B (FIGS. 24, 25, 26) located on a cassette 500. Second actuator surface 649B is an arcuate, curved, or cam surface that provides a camming action to actuate second latch mechanism 532B by engaging latch surface 534B. Second actuator surface 649B is an arcuate, curved, or cam surface. As such, first actuator surface 649A is an arcuate, curved, or cam surface. In this example, first and second actuator surfaces 649A/649B curve or arch outwardly away from a second face 629 at respective first and second ends 626 and 627.

However, it is understood that actuator surface surfaces 534A/534B may comprise any shape, configuration, angle, or radius of curvature as long as such surface actuates the corresponding latch mechanism to release the adaptor holder or gang fiber adaptor assembly such that the adaptor holder or gang fiber adaptor assembly may rotate or tilt within cassette 500 as will be shown and described below herein such as, for example into a second access position (e.g., FIGS. 31, 32. In one such alternative example, actuator surface surfaces 534A/534B may be linear, angled surfaces that engage corresponding linear, angled surfaces of the first and second latch mechanisms on cassette 500.

Adaptor holder 670 may include a first stop 652A (not shown, but the same as a second stop 652B shown in FIG. 20) disposed at first end 626. The first stop 652A may include an angled surface 653A (not shown, but the same as an angled surface 653B of second stop 652B at second end 627). Adaptor holder 670 may also include second stop 652B disposed at second end 627. Second stop 652B may include angled surface 653B. Angled surfaces 653A/653B are oriented at angle α as shown and described herein. In this example, second stop 652B is positioned interior to respective head 642 and latch actuator 648B is interior to stop 652B along longitudinal axis L-L′. First end 626 of adaptor holder 670 includes the same components, features and configuration as detailed above for second end 627.

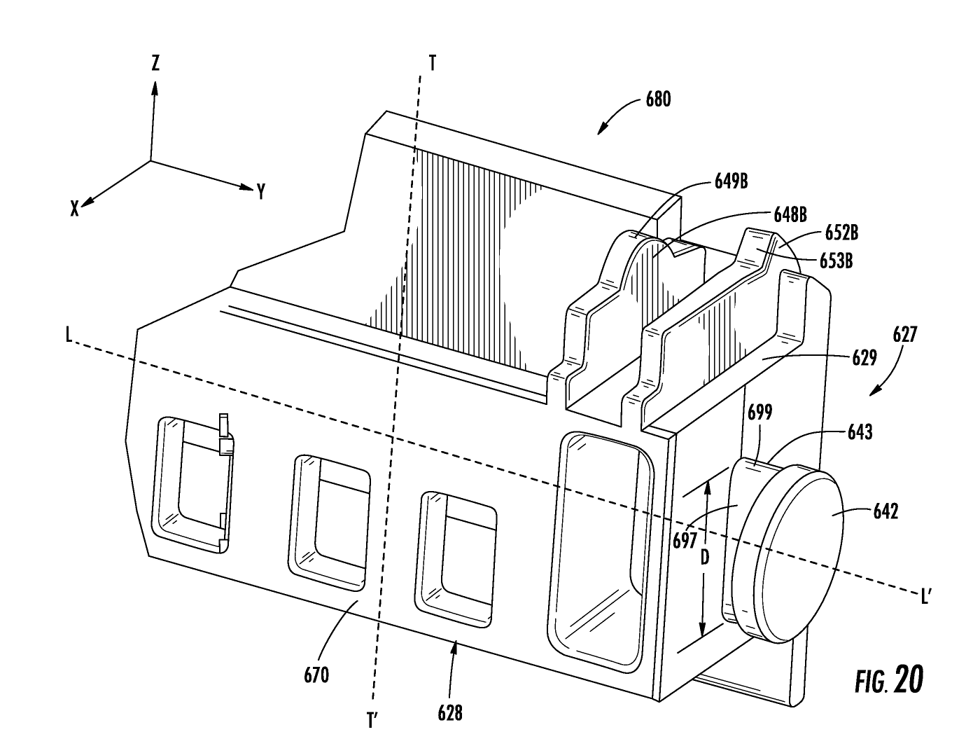

Referring specifically to FIGS. 21-23, a partial section of first side 501 of framework 502 is shown. Head slot 504A includes a first width (W₁), a second width (W₂) and a depth (not shown) sized and configured to accommodate first head 640 of holder 670 and permit it to rotate therein. A wall 510A of first side 501 includes a stem slot 508A which is connected to a stem aperture 512A disposed through wall 510A to head slot 504A. Stem aperture 512A is shaped substantially like two (2) quarter circles. Stem aperture 512A includes a first arcuate section 518A, a first stem stop surface 516A and a second stem stop surface 522A. First stem stop surface 516A is oriented parallel to the Y-Z reference plane. Second stem stop surface 522A is oriented parallel to the X-Y reference plane. Stem aperture 512A also includes a second arcuate section 520A, a third stem stop surface 514A and a fourth stem stop surface 519A. Third stem stop surface 514A is oriented parallel to the X-Y reference plane. Fourth stem stop surface 519A is oriented parallel to the Y-Z reference plane.

First side 501 also includes a first latch mechanism 532A to engage corresponding latch actuator 648A of holder 670 in order to hold adaptor holder 670 or gang adaptor assembly 680 in a first position (FIGS. 26, 28, 33C) within cassette 500. Similarly, second framework side 503 includes a second latch mechanism 532B to engage corresponding latch actuator 648B of holder 670 in order to hold adaptor holder 670 or gang adaptor assembly 680 in the first position (FIGS. 26, 28, 33C) within cassette 500. First and second latch mechanisms 532A/532B may each include a first engagement surface 534A (not shown but the same as 534B) and a second engagement surface 534B, respectively. First and second engagement surfaces 534A/534B correspond with and engage corresponding latch actuator surfaces 649A/649B. In this example, first and second engagement surfaces 534A/534B are arcuate or curved surfaces that are substantially the inverse of latch actuator surfaces 649A/649B.

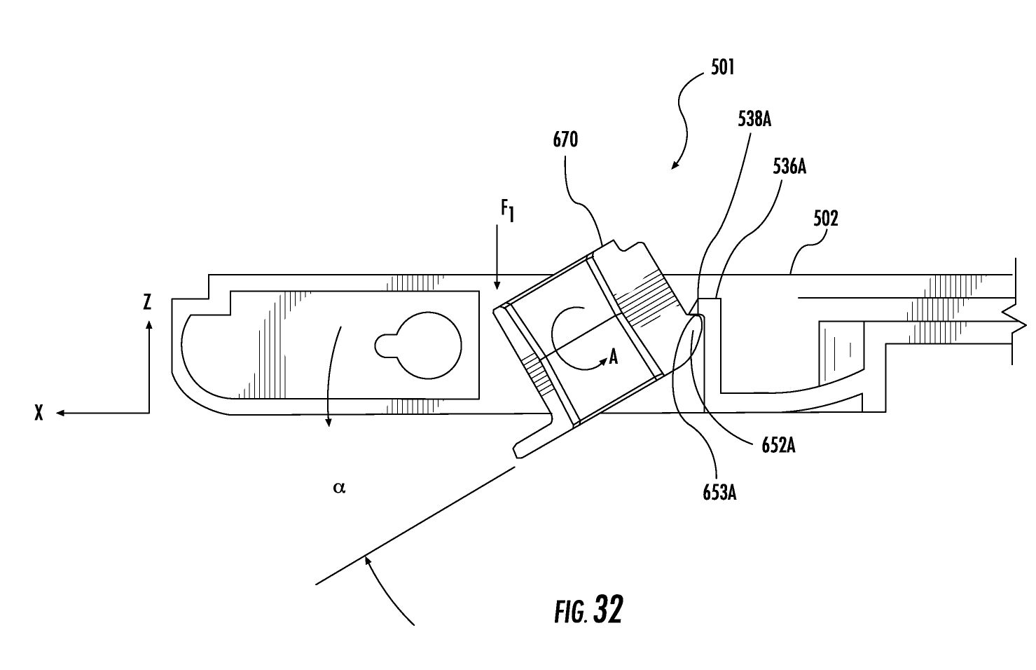

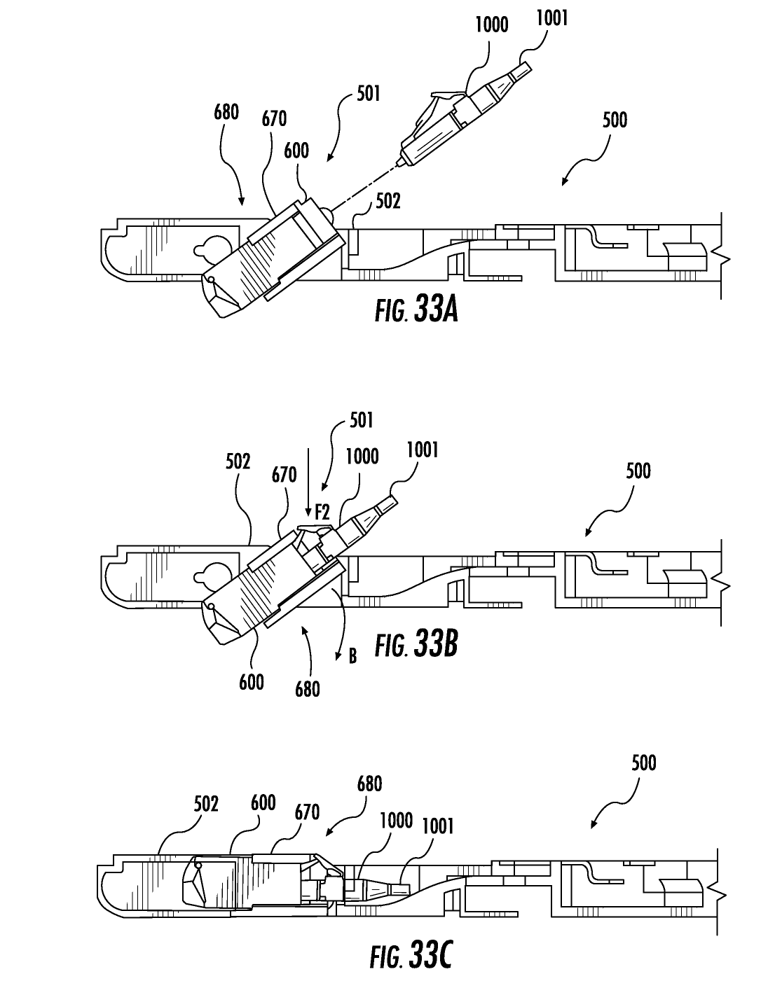

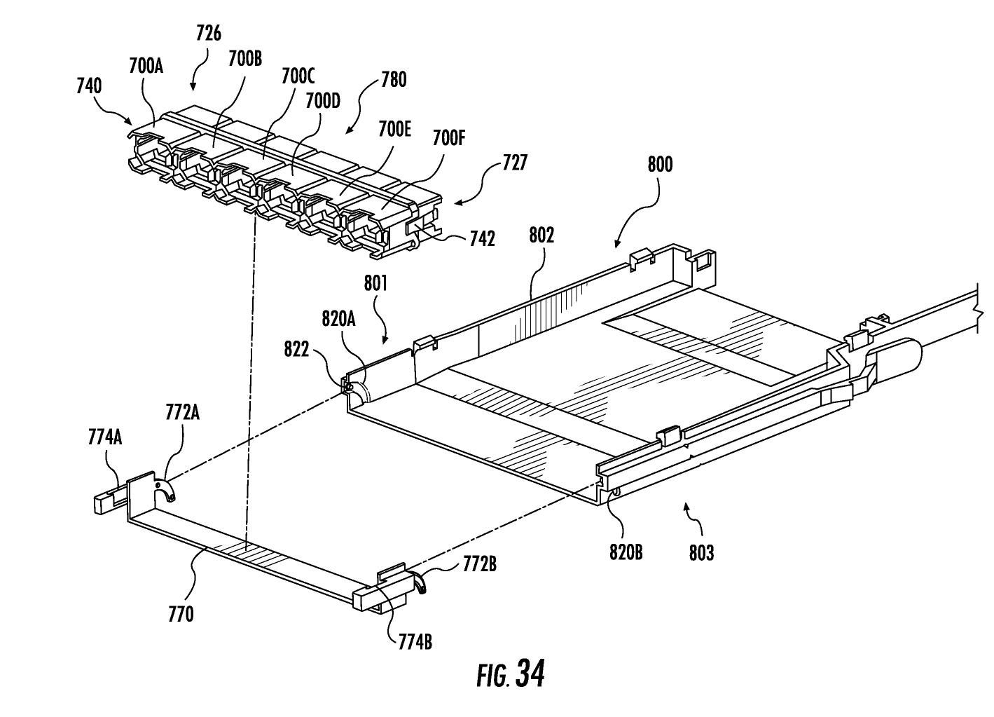

However, it is understood that first and second engagement surfaces 534A/534B may comprise any shape, configuration, angle, or radius of curvature as long as such surfaces engages latch actuator surfaces 649A/649B to latch or lock holder 670 or gang adaptor assembly 680 in the first position and disengages from actuator surfaces 649A/649B when a certain forces is applied to holder 670 or gang adaptor assembly 680 sufficient enough to permit holder 670 or gang adaptor assembly 680 to rotate or tilt within cassette 500 to the second position, i.e., the access position (e.g., FIGS. 32 and 33A). This second position permits a user to have more space and room to access the adaptors and the optical fiber connectors connected thereto as compared to the space and room available when the holder 670 is in the first position (e.g., FIG. 33C). In one such alternative example, actuator surfaces 649A/649B may be linear, angled surfaces that engage corresponding linear, angled surfaces of the first and second latch mechanisms on cassette 500.

Cassette 500 also includes a first cassette stop 536A and a second cassette stop 536B (FIGS. 24 and 25). As shown in FIGS. 21-23, first cassette stop 536A includes a stop surface 538A.

Referring to FIGS. 24-27, second side 503 of framework 502 is shown with second end 627 of holder 670 rotatably connected thereto. For illustration purposes only and to enable a view of stem 643 and its movement within stem aperture 512B, an outside wall 511B (FIG. 19) of framework 502 and head 642 have been removed in FIGS. 24-27. First side 501 of framework 502 and first end 626 of holder are the same as and include the same features and operation as second side 503 and second end 627. Thus, only second side 503 and second end 627 will be shown and described herein for illustration purposes only.

Referring to FIG. 24, holder 670 is shown in a connect/disconnect position within framework 502 of cassette 500. For illustration purposes head 642 has been removed to enable a view of stem 643 within stem aperture 512B. As shown, holder 670 includes a transverse axis T-T′ that is perpendicular to longitudinal axis L-L′. In the load/unload position transverse axis T-T′ is aligned with the Z reference axis. As such, in this position, stem's 643 long side 697 (FIG. 20) having first dimension (D) is also aligned with the Z reference axis. Stem slot 508B has a width that is sufficient enough to permit stem's 643 short side 699 (FIG. 20) having a second dimension (d) to insert therethrough. As such, stem slot 508B has a width of equal to or greater than second dimension (d). When stem 643 is inserted through stem slot 508B, stem 643 fits between first stem stop surface 516B and fourth stem stop surface 519B. As such, first stem stop surface 516B is spaced apart from fourth stem stop surface 519B a distance that is equal to or greater than second dimension (d).

Referring to FIG. 25, a force may be applied to holder 670 to rotate it in the clockwise direction (B) until holder 670 is moved to the second position (e.g., the operational position), i.e., wherein the transverse axis T-T′ is aligned with X reference axis. When in this position, first and second latch actuator surfaces 649A/649B of respective latch actuators 648A/648B engage and lock with respective first and second engagement surface 534A/534B of respective latch mechanisms 532A/532B. Third stem stop surface 514B is spaced apart from second stem stop surface 522B a distance equal to or greater than second dimension (d). In this configuration, third stem stop surface 514B and second stem stop surface 522B prevent stem 643 and thus holder 670 from rotating any further in the clockwise direction (B). Similarly, first stem stop surface 516B and fourth stem stop surface 519B prevent stem 643 and thus holder 670 from rotating any further in the counterclockwise direction (A), when rotated from the second position back to the connect/disconnect position shown in FIG. 24.

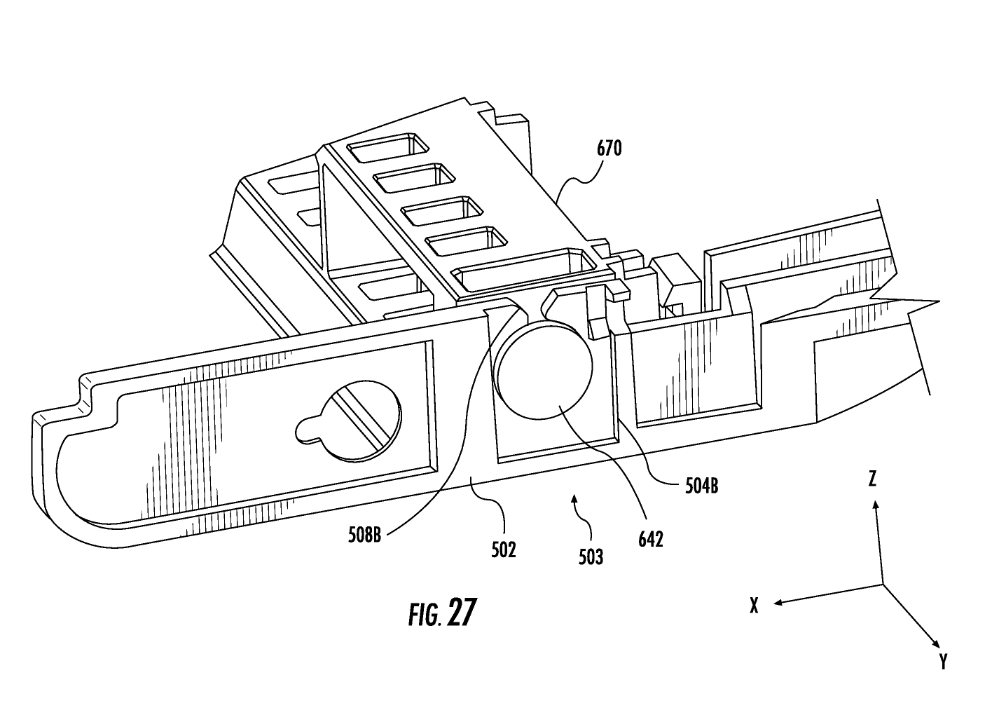

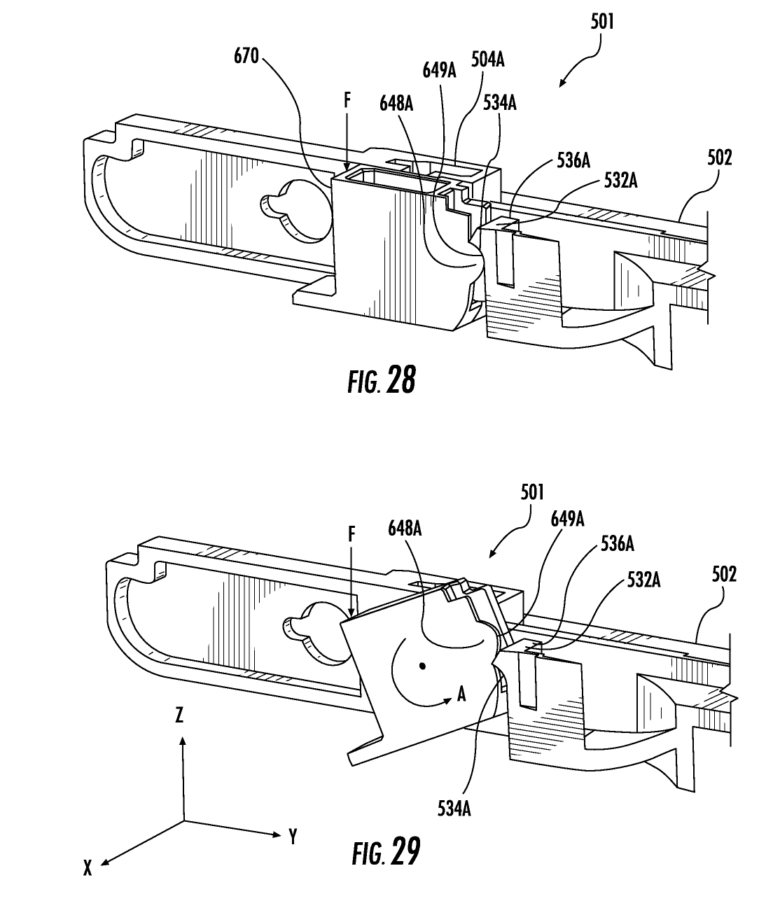

Referring to FIG. 28, a partial view of holder 670 rotatably connected to framework 502 at first side 501 is shown to enable a clearer view of the latch actuator 648A and its actuator surface 649A engage latch mechanism 532A and its engagement surface 534A. In FIG. 28, holder 670 is in the second position. When a force (e.g., force F) is applied to holder 670 one or more of latch actuator surface 649A and engagement surface 534A provides a camming action to push or cause latch mechanism 532A to flare slightly outward away from latch actuator surface 649A, permitting latch actuator 648A to move past and clear latch mechanism 532 as shown in FIG. 29. Referring to FIGS. 29-32, this action permits holder 670 to rotate freely in the counterclockwise direction (A) until first holder stop 652A (and second holder stop 652B) engages first cassette stop 636A (and second cassette stop 636B).

In particular, first holder stop 652A includes an angled surface 653A that is configured or oriented at such an angle such that when it engages a stop surface 538A of cassette stop 536A, it prevents holder 670 from rotating in the counterclockwise direction (A) past an angle α (e.g., FIG. 32). Angle α is determined based upon the desired maximum angle of rotation or tilt of gang adaptor assembly 10 about longitudinal axis L-L′. As such, angle α may comprise any angle of rotation. In certain examples, angle α is about 10°, about 15°, about 20°, about 25°, about 30°, about 35°, about 40°, about 45°, about 50°, about 55°, about 60°, about 65°, about 70°, about 75°, about 80°, about 85°, or about 90°. In such embodiment, gang adaptor assembly 680 or holder 670 may rotate or tilt between a first position angular orientation (e.g., 0°) and angle α. In other embodiments, gang adaptor assembly 680 or holder 670 may be configured to rotate or tilt 360° about axis L-L′. It is understood that second end 627 and second side 503 include the same stops, stop surfaces, features, and operation as describe above with reference to first end 626 and first side 501.

In order to rotate holder 670 in counterclockwise direction (A) past the cassette stop 536A and second cassette stop 536B, an increased force (F1) must be applied to holder 670 in order to cause cassette stop 536A to flare outward away from holder stop 652A such that holder stop 652A may clear and move past the cassette stop 536A, thus enabling holder 670 to continue to rotate in the counterclockwise direction (a) to the load/unload position.

Referring to FIGS. 33A, gang fiber adaptor assembly 680 is shown in the second position within cassette 500, permitting greater space to make a connection of an optical fiber 1001 and its end connector 1000 to adaptor 600 positioned with gang adaptor assembly 680 as compared with the first position (e.g., operational or normal position) within cassette 500 shown in FIG. 33C. FIG. 33B shows that after optical fiber 1001 is connected to adaptor 600, a force (F2) may be applied gang adaptor assembly 680 to cause gang adaptor assembly 680 to rotate in the clockwise direction (b) about longitudinal axis L-L′ toward the first position. FIG. 33C shows gang adaptor assembly 680 resting and locked into is first position with the optical fiber 1001 resting within a storage area within cassette 500.

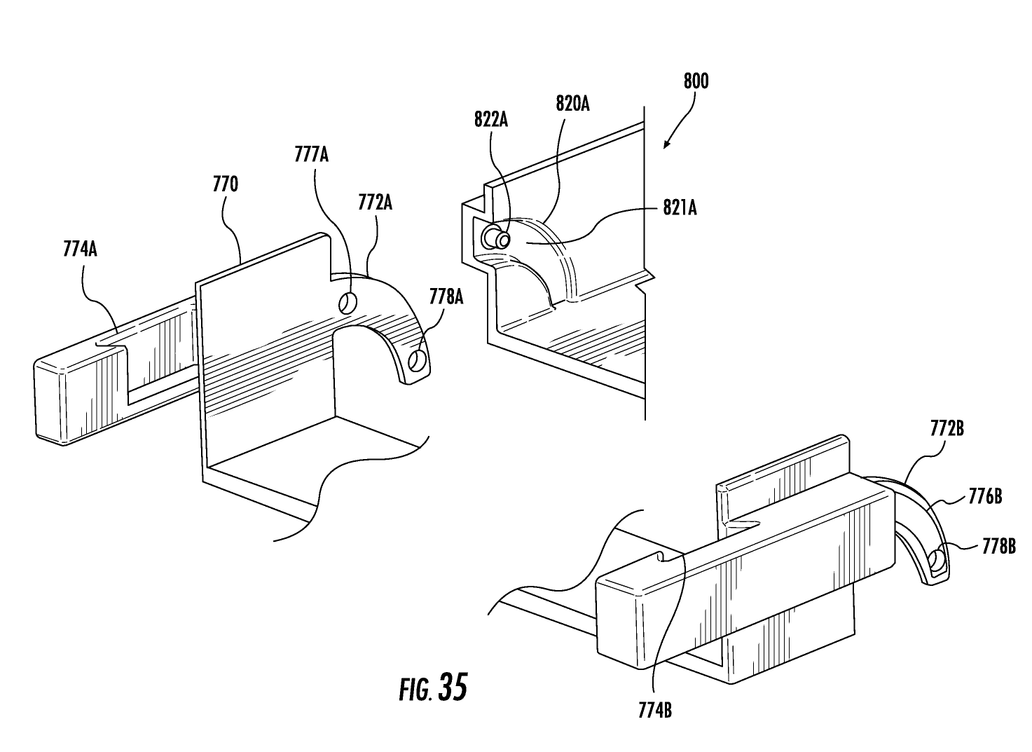

Referring to FIGS. 34-37, another example of a gang fiber adaptor assembly 780 rotatably or tiltably connected to a cassette 800 is shown. Gang fiber adaptor assembly 780 includes a plurality of adaptor connectors 700A-700F ganged together. Gang adaptor assembly 780 includes a first key 740 disposed at first end 726 and a second key 742 disposed at a second end 727 of the assembly. Gang adaptor assembly 680 connects to holder 770 by inserting first and second keys 740 and 742, respectively into respective first and second key holes 774A and 774B located on opposite ends of holder 770.

Additionally, holder 770 includes a first stem 772A extends an arcuate length from a side of holder 770, opposite first key hole 774A. First stem 772A includes a first pin hole 777A and a second pin hole 778A. Holder also includes a second stem 772B that extends an arcuate length from an end of holder 770, opposite first stem 772A, and a side of holder 770, opposite second key hole 774B. Second stem 772B includes a first pin hole 777B and a second pin hole 778B.

Cassette 800 includes a first stem channel 820A disposed on a first side 801 of cassette framework 802. Channel 820A includes an arcuate shape or path that substantially matches the shape of first stem 772A. Channel 820A also includes a pin 822A that is positioned within channel 820A and extends from a bottom surface 821A of channel 802A toward an inner part of cassette 800. Cassette 800 also includes a second stem channel 820B (not shown, but the same as to stem channel 820A) disposed on a second side 803 of cassette framework 802. Channel 820B includes an arcuate shape or path that substantially matches the shape of second stem 772B. Channel 820B also includes a pin 822B (not shown, but the same as to pin 822A) that is positioned within channel 820B and extends from a bottom surface 821B (not shown, but the same as to bottom surface 821A) of channel 820B toward an inner part of cassette 800.

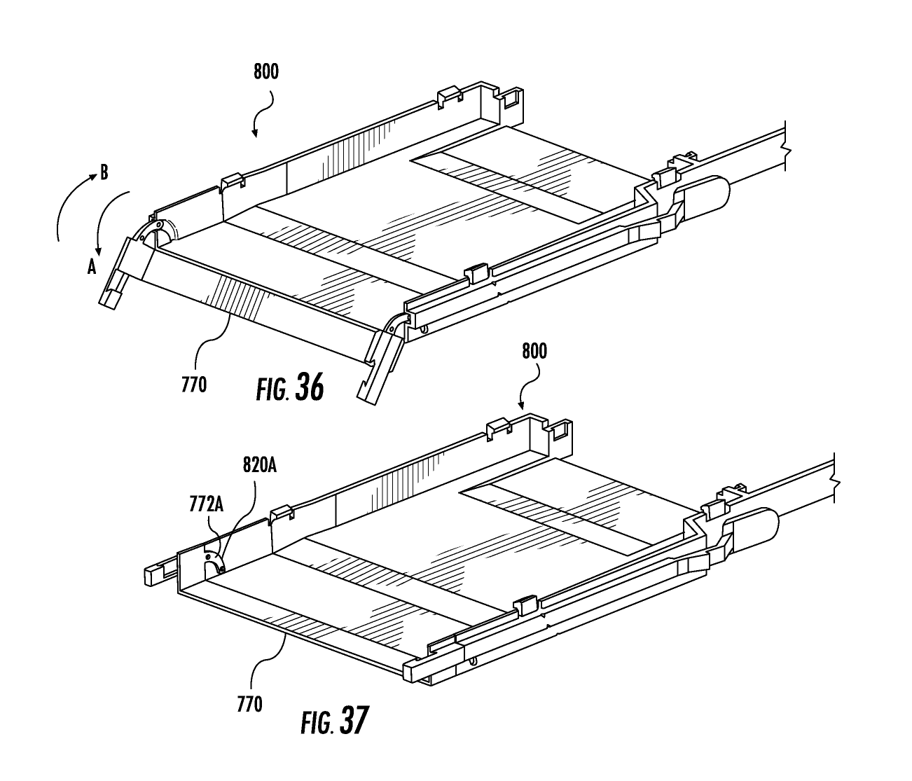

When first and second stems 772A and 772B are inserted into respective first and second channels 820A and 820B, respective first and second pins 822A and 822B insert into and engage respective first pin hole 777A of first stem 772A and second pin hole 777B of second stem 772B. In this position or configuration, holder 770 is tilted or rotated in a counterclockwise direction (A) in a second position (e.g., access position) as shown in FIG. 36. When holder 770 is rotated or tilted in a clockwise direction (B), first and second pins 822A and 822B disengage from first pin holes 777A and 777B and slide within and along first and second channels 820A and 820B until first and second pins 822A and 822B engage and insert into respective second pin hole 778A of first stem 772A and second pin hole 778B of second stem 772B, holding or locking gang adaptor assembly 780 in a first position (e.g., operational or normal position) as shown in FIG. 37. When gang adaptor assembly 780 is rotated or tilted in the second position, this position provides more space or room for a user to access the plurality of adaptors and optical fiber connectors connected therein as compared to when gang adaptor assembly 780 is rotated into the first position. One or more stops may be included in this example to create a hard stop as a specific angle for the second position, including those shown and described herein.

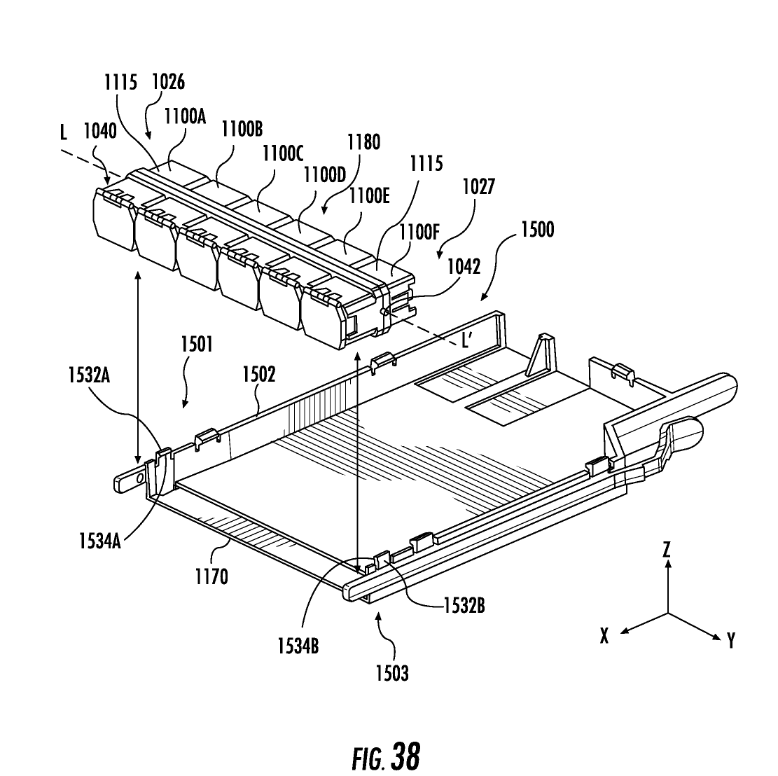

Referring to FIGS. 38-40, another example of a gang fiber adaptor assembly 1180 rotatably or tiltably connected to a cassette 1500 is shown. Gang fiber adaptor assembly 1180 includes a plurality of adaptor connectors 1100A-1100F ganged together. Gang adaptor assembly 1180 includes a first stem 1040 (not shown, but the same as a second stem 1042) extending from a first end 1026 of gang adaptor assembly 1180 along a longitudinal axis L-L′. Additionally, gang adaptor assembly 1180 includes a second stem 1042 extending from a second end 1027, at an end of gang adaptor assembly 1180 opposite first end 1026, along longitudinal axis L-L′. Gang adaptor assembly 1180 is rotatably or tiltably connected to a cassette 1500 by inserting first and second stems 1040 and 1042 into a first stem aperture 1512A disposed within a first side 1501 of a framework 1502 of cassette and a second stem aperture 1512B disposed within a second side 1503 of framework 1502, opposite first side 1501.

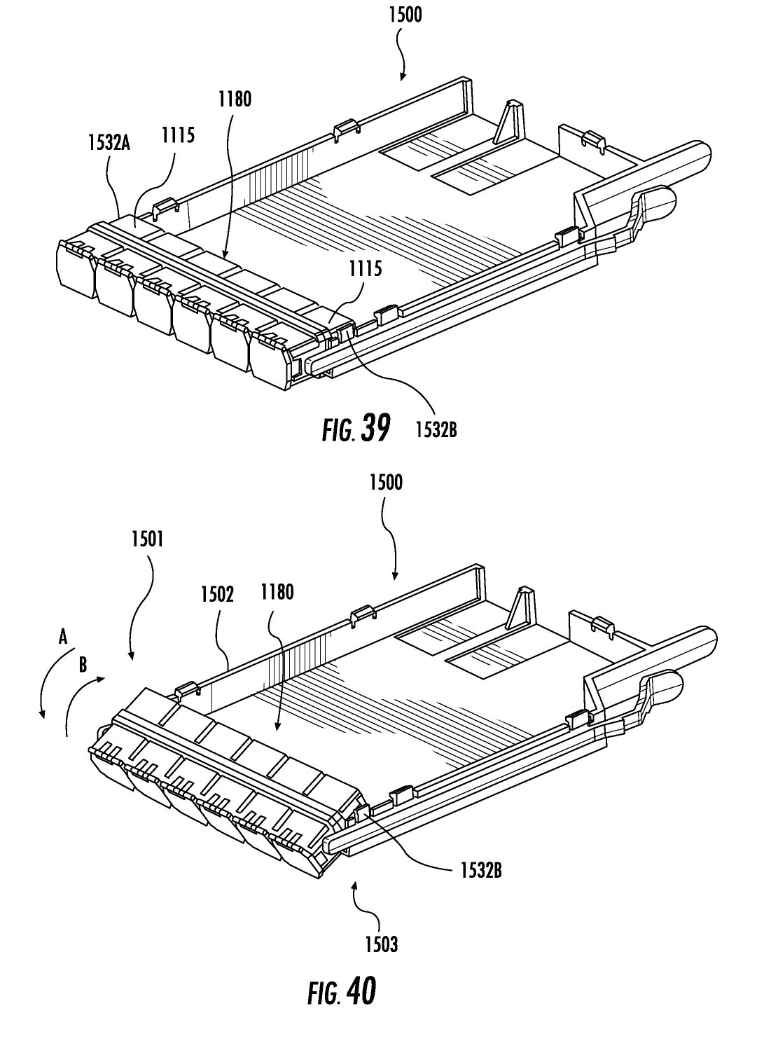

This connection of gang adaptor assembly 1180 to cassette 1500 permits gang adaptor assembly 1180 to rotate or tilt in both a counterclockwise direction (A) and a clockwise direction (B) about the longitudinal axis L-L′. Cassette framework 1502 further includes a first latch mechanism 1532A disposed on first side 1501 and a second latch mechanism 1532B located on a second side 1503. First latch mechanism 1532A includes an engagement surface 1534A. Second latch mechanism 1532B also includes an engagement surface 1534B. In this example, first and second engagement surfaces 1534A and 1534B are oriented inward toward the inner portion of cassette 1500 and are substantially parallel to the X-Y reference place in order to latch or hook an upper surface 1115 of gang adaptor assembly 1180 when gang adaptor assembly 1180 is rotated or tilted into a first position (e.g., operational or normal) as shown in FIG. 39. When first and second engagement surfaces 1534A and 1534B are latched or hooked over gang adaptor assembly 1180, gang adaptor assembly 1180 is locked into the first position.

When a force is applied to gang adaptor assembly sufficient enough to move the gang adaptor assembly 1180 (e.g., surface 1115) past first and second engagement surfaces 1534A and 1534B, gang adaptor assembly 1180 is rotated in counterclockwise direction (A) to a second position (FIG. 40) to permit greater access to adaptors 1100A-1100F while gang adaptor assembly is still attached to cassette 1500 as compared to the first position (FIG. 39). One or more stops may be included in this example to create a hard stop as a specific angle for the second position, including those shown and described herein.

All the rotatable or tillable connections between the adaptor assemblies (or holders) and the cassettes may permit access to the adaptors or adaptor assemblies by a user while the adaptor assemblies are still connected to the cassettes. It is understood that the gang fiber adaptor assemblies, its components, and the cassettes may be manufactured from a variety of materials, including metals, plastics, composites, or any combination thereof, using any number of conventional or yet-to-be developed manufacturing methods. Moreover, it is understood that any and all features and components from the different disclosed examples are interchangeable between the examples.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A gang adaptor assembly comprising:
a plurality of adaptors positioned adjacent to one another along a longitudinal axis;
a first connector disposed at a first end of the gang adaptor assembly and configured to tiltably connect the plurality of adaptors to a cassette;
a second connector disposed at a second end of the gang adaptor assembly and configured to tiltably connect the plurality of adaptors to a cassette;
a latch actuator disposed on at least one of first and second ends, the latch mechanism having a cam surface for actuating a latch mechanism on the cassette; and
a stop disposed on at least one of first and second ends, the stop configured to prevent the plurality of adaptors for rotating within cassette beyond an angle α.

2. The gang adaptor assembly of claim 1, wherein the angle α is about 45°.

3. The gang adaptor assembly of claim 1, wherein the angle α is about 30°.

4. The gang adaptor assembly of claim 1, wherein the first connector comprises a first stem that extends from the first end and the second connector comprises a second stem that extends from the second end.

5. The gang adaptor assembly of claim 4, wherein the first stem extends from the first end along the longitudinal axis and the second stem extends from the second end along the longitudinal axis.

6. The gang adaptor assembly of claim 5, wherein a first head is disposed on a distal end of the first stem and a second head is disposed on a distal end of the second stem.

7. The gang adaptor assembly of claim 6, wherein the first and second stems have a first side having a first dimension (D) and a second side having a second dimension (d), wherein the first dimension (D) is greater than the second dimension (d).

8. The gang adaptor assembly of claim 7, where the first dimension (D) is two times greater than the second dimension (d).

9. The gang adaptor assembly of claim 4, wherein the first stem extends from the first end transverse to the longitudinal axis along an arcuate path and the second stem extends from the second end transverse to the longitudinal axis along an arcuate path.

10. The gang adaptor assembly of claim 9, wherein the first and second stems each comprise an arcuate channel disposed within a side of the stem.

11. The gang adaptor assembly of claim 1, wherein:
each adaptor of the plurality of adaptors has a body that includes a pair of opposed short sides having a length (l) and a pair of opposed long sides having a length (L);
the length (L) is greater than the length (l); and
the plurality of adaptors are oriented adjacent to one another along the longitudinal axis such that the pair of opposed long sides are substantially transverse to the longitudinal axis and the pair of opposed short sides are substantially parallel to the longitudinal axis.

12. A gang adaptor assembly comprising:
a holder having a longitudinal axis, a first end, a second end opposite the first end;
a first connector disposed at the first end, the first connector comprising:
a first stem extending from the first end along the longitudinal axis, and
a first head disposed on a distal end of the stem;
a second connector disposed at the second end, the second connector comprising:
a second stem extending from the second end along the longitudinal axis, and
a second head disposed on a distal end of the stem;
a plurality of adaptors positioned adjacent to one another along a longitudinal axis; and
a latch actuator disposed on at least one of first and second ends, the latch mechanism having a cam surface for actuating a latch mechanism on the cassette.

13. The gang adaptor assembly of claim 12, further comprising a stop disposed on at least one of first and second ends, the stop configured to prevent the plurality of adaptors for rotating within cassette beyond an angle α.

14. The gang adaptor assembly of claim 12, wherein the angle α is from about 15° about 60°.

15. The gang adaptor assembly of claim 12, wherein the latch actuator comprises a cam surface to engage and actuate a latch mechanism on a cassette.

16. The gang adaptor assembly of claim 15, wherein the cam surface is an arcuate surface extending from the holder.

17. The gang adaptor assembly of claim 12, wherein the holder and the plurality of adaptors are a single, integral assembly.

18. An optical fiber cassette comprising:
a framework having a first side and a second side opposite the first side, the framework comprising:
a first stem aperture disposed within the first side, and
a second stem aperture disposed within the second side opposite and axially-aligned with the first stem; and
a gang adaptor assembly comprising:
a first end,
a second end opposite the first end,
a plurality of adaptors positioned adjacent to one another along a longitudinal axis between first and second ends,
a first connector disposed at the first end, the first connector comprising a first stem extending from the first end and received with the first stem aperture,
a second connector disposed at the second end, the second connector comprising a second stem extending from the second end and received with the second stem aperture, and
a latch actuator disposed on at least one of first and second ends, the latch mechanism having a cam surface for actuating a latch mechanism on the cassette;
wherein first and second connectors tiltably connect the plurality of adaptors to the framework, permitting the plurality of adaptors to tilt relative to the framework.

19. The optical fiber cassette of claim 18, wherein the plurality of adaptors tilts relative to the framework at angle α from about 0° to about 90°.

20. The optical fiber cassette of claim 18, wherein the first side of the framework comprises a head slot disposed therein, and the second side of the framework comprises a head slot disposed therein.

21. The optical fiber cassette of claim 20, wherein the head slot on the first side is connected to the first stem aperture and the head slot on the second side is connected to the second stem aperture.

22. The optical fiber cassette of claim 21, wherein the first side comprises a stem slot disposed therein that is connected to the head slot and first stem aperture, and the second side comprises a stem slot disposed therein that is connected to the head slot and second stem aperture.

23. The optical fiber cassette of claim 22, wherein each one of the first and second stem apertures comprises:
a first arcuate section, a first stem stop surface disposed on one side of the first arcuate section, and a fourth stem stop surface disposed on a side of the first arcuate section opposite the first stem stop surface; and
a second arcuate section, a second stem stop surface disposed on one side of the second arcuate section, and a third stem stop surface disposed on a side of the second arcuate section opposite the second stem stop surface.

24. The optical fiber cassette of claim 22, wherein the gang adaptor assembly comprises a first head disposed on a distal end of the first stem and a second head disposed on a distal end on the second stem, wherein the first head is received within the first head slot and the first stem is received within the first stem slot, and wherein the second head is received within the second head slot and the second stem is received within the second stem slot.
